(19) United States
(12) Patent Application Publication
(10) Pub. No.: US 2014/0310026 A1
(43) Pub. Date: Oct. 16, 2014

(54) SYSTEMS, APPARATUS, AND METHODS FOR CUSTOMER-DRIVEN INSURANCE CLAIM MANAGEMENT

(71) Applicant: The Travelers Indemnity Company, Hartford, CT (US)

(72) Inventors: Amy Balthazar, Manchester, CT (US); Michael Strietelmeier, Enfield, CT (US)

(73) Assignee: The Travelers Indemnity Company, Hartford, CT (US)

(21) Appl. No.: 14/250,124

(22) Filed: Apr. 10, 2014

Related U.S. Application Data
(60) Provisional application No. 61/811,228, filed on Apr. 12, 2013.

(51) Int. Cl. G06Q 40/08

(52) U.S. Cl. CPC G06Q 40/08
USPC 705/4

(57) ABSTRACT

Systems, apparatus, methods, and articles of manufacture provide for facilitating management of insurance claims, including providing a claim management interface (e.g., a claim management dashboard) for facilitating review of one or more particular claims according to one or more user-selected preferences (e.g., threshold amounts associated with a claim, types of changes to claims).

### BACKGROUND

Business insurance customers often must analyze volumes of data to attempt to identify particular claims that may require, for example, additional oversight, resources, or review to reduce and/or prepare for expected insurance loss costs. A typical individual or entity insurance customer is unlikely to develop criteria, analysis, strategies, and/or procedures for managing insurance claims in a way that is efficient and/or designed to identify insurance claims to minimize overall claim costs.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a block diagram of a system according to some embodiments;

FIG. 2 is a block diagram of a system according to some embodiments;

FIG. 3A and FIG. 3B are diagrams of an example data storage structure according to some embodiments;

FIG. 4 is a flow diagram of a method according to some embodiments;

FIG. 5A, FIG. 5B, FIG. 5C, FIG. 5D, FIG. 5E, and FIG. 5F are example interfaces according to some embodiments;

FIG. 6 is a block diagram of an apparatus according to some embodiments; and

FIG. 7 is a flow diagram of a method according to some embodiments.

### DETAILED DESCRIPTION

Embodiments presented herein are descriptive of systems, apparatus, methods, and articles of manufacture for customer-driven insurance claim management. In some embodiments, for example, an interface or “dashboard” may be provided that allows a customer to identify, manage, and/or otherwise process or analyze insurance claims associated with the customer.

Applicants have recognized that, in accordance with one or more embodiments, some types of insurers, customers, and/or claim professionals may find it advantageous to provide, have access to, and/or utilize functions of a claim management service and/or dashboard providing for one or more of the following benefits: (i) provides an interface for customers to analyze all open claims and/or those claims meeting one or more criteria (e.g., for which recent activities may have a significant impact on overall loss costs); (ii) provides users with information for claim management in a single interface without having to understand intricacies involved in managing claims; (iii) determines and/or presents relevant metrics, milestones, and/or attributes of claims (e.g., for use in identifying one or more claims for research that meet one or more criteria); (iv) determines and/or presents information about one or more claims that may be associated with high costs and/or red flags; (v) summarizes, filters, and/or organizes claims and claim information based on key metrics; (vi) provides guided claim management analysis; (vii) improves efficiency of claim management practices by an insurance carrier's internal customers (e.g., account executives) and external business customers (e.g., insured businesses); (viii) provides information accessible on one or more mobile, wired, and/or wireless platforms; (ix) provides an interactive user interface by which a user may change how information is presented (e.g., by changing sort fields); (x) provides an interactive user interface by which a user may move from a display of high-level summary information to detailed, individual claim data for analysis; (xi) provides an interactive user interface by which a user may change sort fields; (xii) simplifies the claim review process, eliminates manual steps, and/or saves time of customers and claim professionals; (xiii) reduces the volume of formal on-site claim reviews (e.g., by providing a self-service application for customers); (xiv) provides an on-line collaboration service for claim professionals and customers to share information about and/or review claims collaboratively; (xv) identifies and transmits to users information about claims determined based on customer-driven criteria; and/or (xvi) utilizes a browser and device agnostic technology platform, including support for mobile devices.

Applicants further have recognized that, in accordance with one or more embodiments, some types of customers and claim professionals may find it advantageous to have access to an interactive tool for automating one or more aspects of a claim review process. In some embodiments, the interactive tool may provide for one or more of the following: (i) automatic delivery of claim review information to users, (ii) reduced reliance on manual touch points, (iii) improved electronic collaboration and electronic distribution of presentation quality claim review packages, (iv) support for all lines of insurance (e.g., for an insured); (v) analyzing claim inventory; (vi) analyzing claim distributions (e.g., based on location, office, claim type), (vii) drilling down to claim review details; (viii) producing file review packages; and/or (ix) user annotations of claim review information (e.g., to improve collaboration efforts among two or more claims professionals and/or insureds).

Applicants further have recognized that, in accordance with one or more embodiments, some types of customers may find it advantageous to have access to and/or utilize functions of a virtual claim review service (e.g., utilizing a claim management dashboard) providing for one or more of the benefits and/or features described in this disclosure.

In accordance with some embodiments of the present invention, one or more systems, apparatus, methods, articles of manufacture, and/or computer readable media (e.g., a non-transitory computer readable memory storing instructions for directing a processor) are described that provide for one or more of the following: (i) determining claim information; (ii) providing a claim management interface; and/or (iii) receiving information input by a customer (e.g., preferences of a user for use in determining and/or presenting claim review information).

In accordance with some embodiments of the present invention, one or more systems, apparatus, methods, articles of manufacture, and/or computer readable media (e.g., a non-transitory computer readable memory storing instructions for directing a processor) are described that provide for one or more of the following: (i) determining at least one user preference for determining at least one claim; (ii) determining a threshold amount for selecting open claims; (iii) determining an activity time period for selecting claims based on activity on the claim; (iv) determining a threshold amount for selecting claims based on changes in the claim amount; (v) determining a threshold amount for selecting claims based on the amount paid on the claim; (vi) determining claim count information (e.g., associated with a customer) based on one or more preferences; (vii) transmitting and/or displaying claim count information via a claim management interface; (viii) receiving from a user at least one preference for selecting claims for claim review; (ix) receiving from a user a selection of a claim count (e.g., displayed via a claim management interface) associated with one or more claims; (x) displaying claim detail information (e.g., via a claim management interface) for one or more claims selected by a user (e.g., via the claim management interface).

As used herein, the term “customer” may generally refer to any type, quantity, and or manner of entity for which (or by which) insurance loss costs and/or other resource allocations associated with one or more insurance claims may be estimated, quantified, calculated, predicted, identified, and/or otherwise determined. A customer may comprise a business insurance policy holder, for example, and/or may comprise another entity that seeks to determine insurance information associated with one or more insurance claims (e.g., potential loss costs, activity related to one or more claims), for example, a professional employed by or otherwise associated with an insurer (e.g., issuing an insurance policy). A customer may have an existing business relationship with other entities described herein, such as an insurance company for example, or may not yet have such a relationship. For instance, a customer may comprise a “potential customer” (e.g., in general and/or with respect to a specific product offering). In some embodiments, a customer may comprise a user of an interface (e.g., whether or not such a user conducts a purchase or seeks to conduct a purchase). A user may comprise, for example, an agent, underwriter, and/or other employee or personnel of an entity seeking to analyze, determine, and/or manage claim information, such as a consultant and/or insurer, for example.

As used herein, the terms “medical dollars” and “medical amount” refer to medical expenses (paid or to be paid) associated with an insurance claim (e.g., to provide medical care to an injured worker based on a workers compensation (WC) claim).

As used herein, the terms “claim dollars” and “claim amount” refer to non-medical amounts (paid or to be paid to a claimant) associated with an insurance claim (e.g., payouts for property damage, auto damage).

As used herein, the terms “expense dollars” and “expense amount” refer to expenses incurred by a customer and/or insurance carrier (other than medical amounts or claim amounts) and associated with an insurance claim (e.g., attorney fees for related litigation).

As used herein, the terms “paid dollars” and “paid amount” refers to previously paid amounts that are associated with a claim. As used herein, the terms “reserved amount,” “reserved dollars,” “incurred dollars,” and “incurred amount” refer to expected and/or potential amounts to be paid with respect to an insurance claim.

Some embodiments described herein are associated with a “customer device” or a “network device.” As used herein, a customer device is a subset of a network device. The network device, for example, may generally refer to any device that can communicate via a network, while the customer device may comprise a network device that is owned or operated by or otherwise associated with a customer. Examples of customer and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Customer and/or network devices may comprise one or more network components.

As used herein, the term “network component” may refer to a customer or network device, or a component, piece, portion, or combination of customer or network devices. Examples of network components may include a Static Random Access Memory (SRAM) device or module, a network processor, and a network communication path, connection, port, or cable.

As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

In cases where video signals or large files are being sent over the network, a broadband network may be used to alleviate delays associated with the transfer of such large files, however, such an arrangement is not required. Each of the devices may be adapted to communicate on such a communication means. Any number and type of machines may be in communication via the network. Where the network is the Internet, communications over the Internet may be through a website maintained by a computer on a remote server or over an online data network, including commercial online service providers, and/or bulletin board systems. In yet other embodiments, the devices may communicate with one another over RF, cable TV, and/or satellite links. Where appropriate, encryption or other security measures, such as logins and passwords, may be provided to protect proprietary or confidential information.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

As used herein, “determining” includes calculating, computing, deriving, looking up (e.g., in a table, database, or data structure), ascertaining, and/or recognizing.

As used herein, “processor” means any one or more microprocessors, Central Processing Unit (CPU) devices, computing devices, microcontrollers, and/or digital signal processors. As used herein, the term “computerized processor” generally refers to any type or configuration of primarily non-organic processing device that is or becomes known. Such devices may include, but are not limited to, computers, Integrated Circuit (IC) devices, CPU devices, logic boards and/or chips, Printed Circuit Board (PCB) devices, electrical or optical circuits, switches, electronics, optics and/or electrical traces. As used herein, “mechanical processors” means a sub-class of computerized processors, which may generally include, but are not limited to, mechanical gates, mechanical switches, cogs, wheels, gears, flywheels, cams, mechanical timing devices, etc.

As used herein, the terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “non-transitory” and/or “tangible,” when used in reference to computer-readable media or memories, specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement one or more of the various practices described in this disclosure.

A computer system of an insurance company may, for example, comprise various specialized computers that interact to perform claim management assessments, as described in this disclosure.

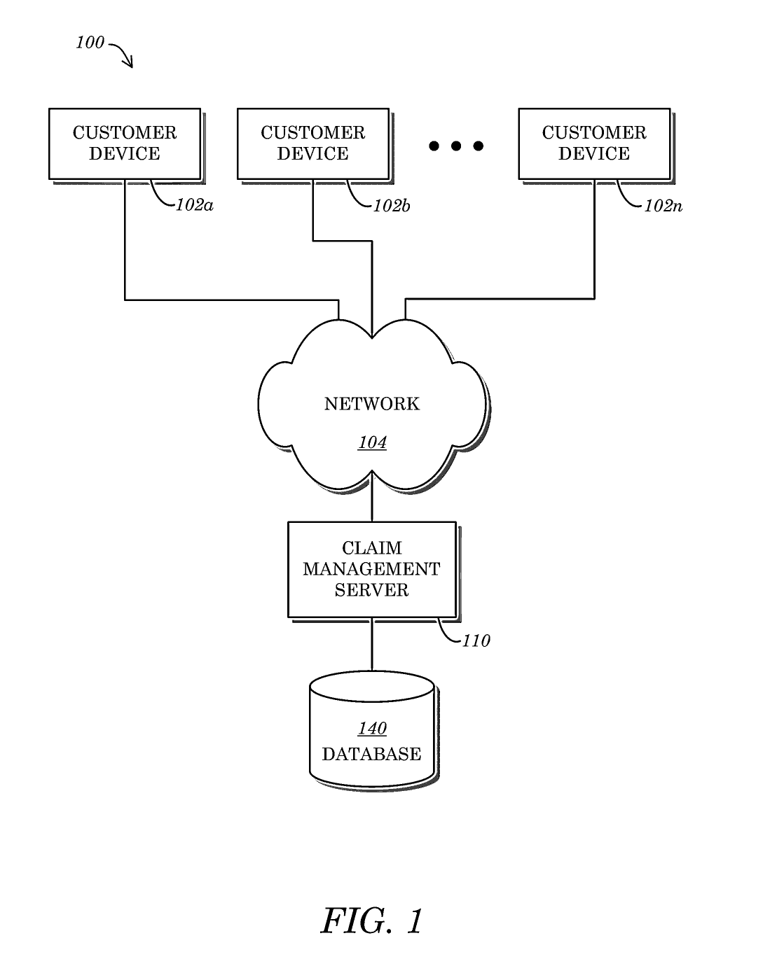

Turning first to FIG. 1, a block diagram of a system 100 according to some embodiments is shown. In some embodiments, the system 100 may comprise a plurality of customer devices 102a-n in communication with and/or via a network 104. In some embodiments, a claim management server 110 may be in communication with the network 104 and/or one or more of the customer devices 102a-n. In some embodiments, the claim management server 110 (and/or the customer devices 102a-n) may be in communication with a database 140. The database 140 may store, for example, data associated with customers and/or one or more claims related to customers owning and/or operating the customer devices 102a-n, and/or instructions that cause various devices (e.g., the claim management server 110 and/or the customer devices 102a-n) to operate in accordance with embodiments described in this disclosure.

The customer devices 102a-n, in some embodiments, may comprise any type or configuration of electronic, mobile electronic, and or other network and/or communication devices (or combinations thereof) that are or become known or practicable. The first customer device 102a may, for example, comprise one or more PC devices, computer workstations (e.g., underwriter workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the customer devices 102a-n may be specifically utilized and/or configured (e.g., via specially-programmed and/or stored instructions such as may define or comprise a software application) to communicate with the claim management server 110 (e.g., via the network 104).

The network 104 may, according to some embodiments, comprise LAN, WAN, cellular telephone network, Bluetooth® network, NFC network, and/or RF network with communication links between the customer devices 102a-n, the claim management server 110, and/or the database 140. In some embodiments, the network 104 may comprise direct communications links between any or all of the components 102a-n, 110, 140 of the system 100. The claim management server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. The second customer device 102b may, for example, be connected to the claim management server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 110, 140 of the system 100. The network 104 may comprise one or more cellular telephone networks with communication links between the customer devices 102a-n and the claim management server 110, for example, and/or may comprise the Internet, with communication links between the customer devices 102a-n and the database 140, for example.

According to some embodiments, the claim management server 110 may comprise a device (or system) owned and/or operated by or on behalf of or for the benefit of an insurance company. The insurance company may utilize claim information (e.g., open claims associated with a customer), in some embodiments, to manage, analyze, select, and/or otherwise determine information for use in managing claims.

In some embodiments, the insurance company (and/or a third-party, not explicitly shown) may provide an interface (not shown in FIG. 1) to and/or via the customer devices 102a-n. The interface may be configured, according to some embodiments, to allow and/or facilitate claim management, analysis, and/or other processing of claim data by one or more customers. In some embodiments, the system 100 (and/or interface provided by the claim management server 110) may present data related to claims (e.g., from the database 140) in such a manner that allows customers to make informed claim management decisions.

In some embodiments, the database 140 may comprise any type, configuration, and/or quantity of data storage devices that are or become known or practicable. The database 140 may, for example, comprise an array of optical and/or solid-state hard drives configured to store data and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the customer devices 102a-n may comprise the database 140 or a portion thereof, for example, and/or the claim management server 110 may comprise the database 140 or a portion thereof.

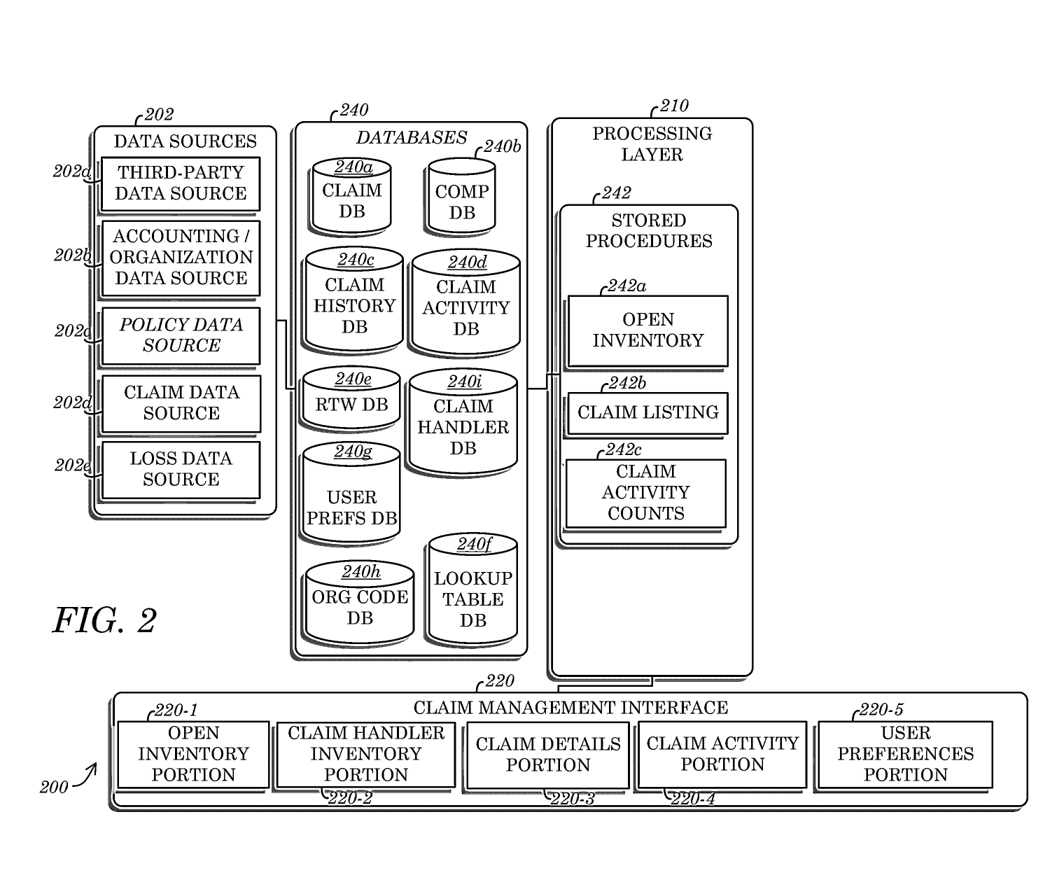

Referring now to FIG. 2, a block diagram of a system 200 according to some embodiments is shown. In some embodiments, the system 200 may comprise a plurality of data sources 202, a processing layer 210, a claim management interface 220, and/or a plurality of databases 240. In some embodiments, the system 200 and/or the processing layer 210 may comprise a plurality of stored procedures 242. According to some embodiments, any or all of the components 202, 210, 220, 240, 242 of the system 200 may be similar in configuration and/or functionality to any similarly named and/or numbered components described in this disclosure. Fewer or more components 202, 210, 220, 240, 242 (and/or portions thereof) and/or various configurations of the components 202, 210, 220, 240, 242 may be included in the system 200 without deviating from the scope of embodiments described herein. Any component 202, 210, 220, 240, 242 depicted in the system 200 may comprise a single device, a combination of devices and/or components 202, 210, 220, 240, 242, and/or a plurality of devices, as is or becomes desirable and/or practicable. Similarly, in some embodiments, one or more of the various components 202, 210, 220, 240, 242 may not be needed and/or desired in the system 200.

According to some embodiments, any or all of the data sources 202 may be coupled to, configured to, oriented to, and/or otherwise disposed to provide and/or communicate data to one or more of the databases 240. A third-party data source 202a (e.g., an Other Carrier Data (OCD) source), an accounting/organization data source 202b, a policy data source 202c, a claim data source 202d, and/or a loss data source 202e may, for example, provide data that may be fed into one or more of a claim database 240a, a workers compensation (“comp”) database 240b, a claim history database 240c, a claim activity database 240d, a return to work (“RTW”) database 240e, a lookup table database 240f, a user preferences database 240g, an organization code database 240h, and/or a claim handler database 240i. In some embodiments, the data from the data sources 202a-i may comprise insurance and/or other data descriptive of, assigned to, and/or otherwise associated with a customer (or group of customers) and/or with one or more claims.

In some embodiments, the data stored in any or all of the databases 240a-i may be utilized by the processing layer 210. The processing layer 210 may, for example, execute and/or initiate one or more of the stored procedures 242 to process the data in the databases 240a-i (or one or more portions thereof) and/or to define one or more summary tables (e.g., for use in presenting information via the claim management interface 220. In some embodiments, the stored procedures 242 may comprise one or more of an open inventory procedure 242a, a claim listing procedure 242b, and/or a claim activity counts procedure 242c.

In some embodiments, the lookup table database 240f may store records that may be useful, for example, for looking up information based on one or more different types of codes or other identifiers. In one example, lookup table database 240f may comprise records comprising unique state codes in association with other respective state information (e.g., state name, country name) and/or records comprising unique adjusting office codes in association with other respective information about each adjusting office (e.g., city and state where that office is located). Accordingly, an application may look up additional information about a particular state and/or adjusting office based on a corresponding code (e.g., stored in claim records) in order to display the information via a user interface.

According to some embodiments, the execution of the stored procedures 242a-c may define, identify, calculate, create, and/or otherwise determine one or more summary tables. In some embodiments, one or more of the databases 240a-i and/or associated summary tables determined via one or more of stored procedures 242a-c may drive, power, define, support, underlie, and/or otherwise determine each of a plurality of portions of the claim management interface 220. Accordingly, any references to databases 240a-i in describing various embodiments in this disclosure may be understood as applying to, alternatively or in addition, one or more summary data tables.

In one example, one or more of open inventory portion 220-1, claim handler inventory portion 220-2, claim details portion 220-3, and/or claim activity portion 220-4 of the claim management interface 220 may display data from the claim database 240a, workers compensation (“comp”) database 240b, claim history database 240c, claim activity database 240d, RTW database 240e, lookup table database 240f, organization code database 240h, and/or claim handler database 240i. In another example, user preferences portion 220-5 may display data from user preferences database 240g.

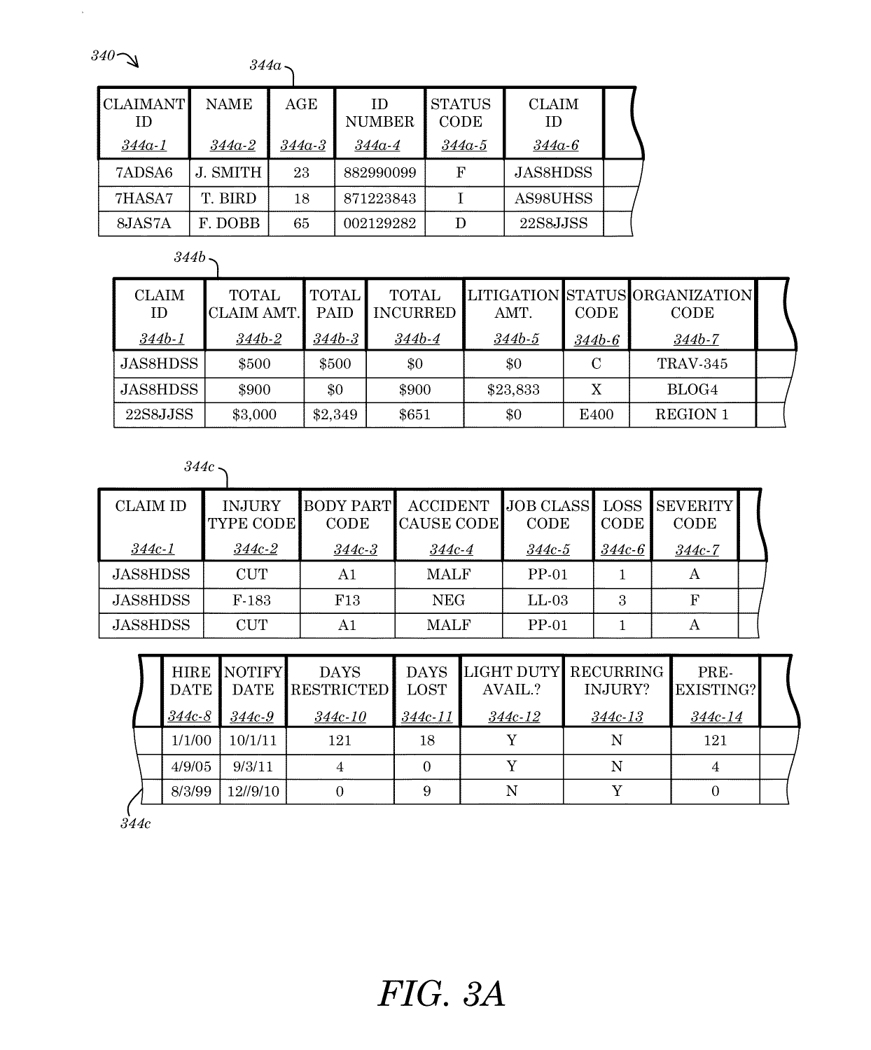

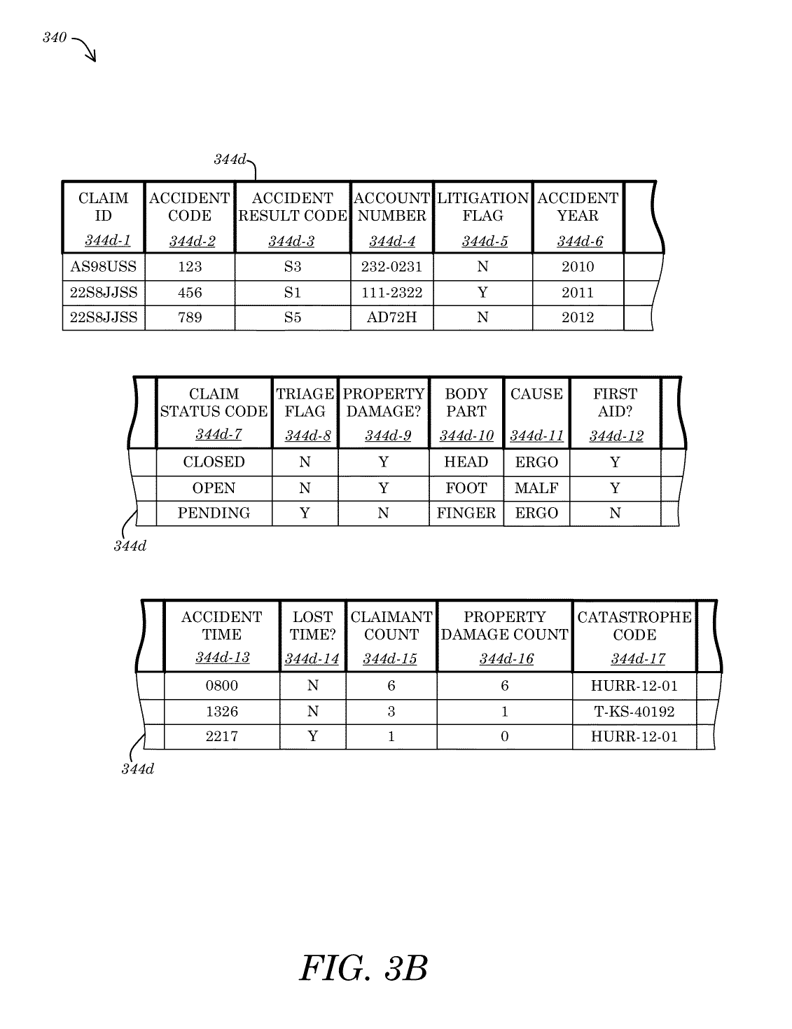

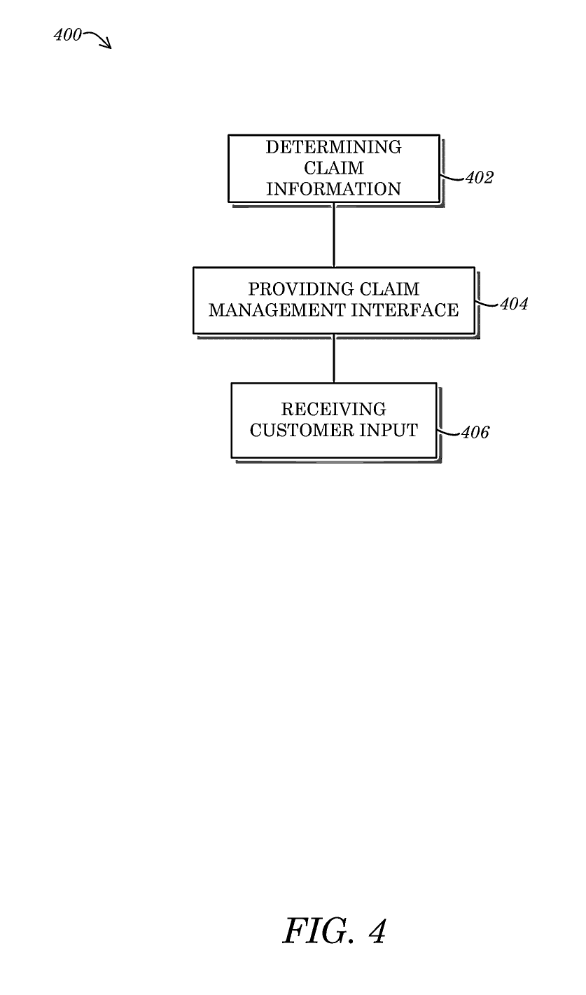

Referring to FIG. 3A and FIG. 3B, diagrams of an example data storage structure 340 according to some embodiments are shown. In some embodiments, the data storage structure 340 may comprise a plurality of data tables such as a claimant table 344a, a claim history table 344b, a workers compensation (“comp”) table 344c, and/or a claims table 344d. The data tables 344a-d, a workers compensation table, and/or a return to work table may, for example, be utilized (e.g., at 404 of the method 400 of FIG. 4) to determine, define, calculate, define, and/or provide a customer-driven claim management interface as described herein.

The claimant table 344a may comprise, in accordance with some embodiments, a claimant identifier (ID) field 344a-1 that includes an identifier that uniquely identifies a claimant, a name field 344a-2 that indicates a name of the claimant, an age field 344a-3 that indicates an age of the claimant (e.g., an age of an injured individual at the time of an injury), an ID number field 344a-4, a status code field 344a-5 that indicates a status of the respective claimant record, and/or a claim ID field 344a-6 that includes an identifier that uniquely identifies a claim. Any or all of the fields 344a-1-344a-6 may generally store any type of identifier that is or becomes desirable or practicable (e.g., a unique identifier, an alphanumeric identifier, and/or an encoded identifier).

In accordance with some embodiments, the claimant table 344a may comprise, alternatively or in addition, one or more of a last update time field that indicates a time (e.g., a day and/or time) that the last insert or update was made on the table, a social security number field that includes a social security number associated with a corresponding claimant, a gender code field that includes an indication of a gender of a corresponding claimant (e.g., male or female), a date of death field that indicates a date that a corresponding claimant died, a close date field that indicates a date that a corresponding claim file was closed, and/or a fatality indicator field that indicates whether or not a corresponding claimant's injuries were fatal.

The claim history table 344b may comprise, in accordance with some embodiments, a claim ID field 344b-1 that includes an identifier that uniquely identifies a claim, a total claim amount field 344b-2 that indicates a total amount associated with a corresponding claim, a total paid amount field 344b-3 that indicates a total previously paid for a corresponding claim, a total incurred amount field 344b-4 that indicates a total reserved expense amount (or total “incurred” expense amount) associated with a corresponding claim, a litigation amount field 344b-5 that indicates a total amount of expenses for litigation associated with the claim, a status code field 344b-6 that indicates a status of a corresponding claim, and/or an organization field 344b-7 that indicates a business unit, division, or other type of business entity responsible for a corresponding claim loss.

According to some embodiments, the total claim amount is based on (e.g., is a sum of) a total reserved expense amount associated with a claim (e.g., a total expected future claim exposure or other outstanding amount) and a total paid amount associated with the claim (e.g., an amount previously paid for medical expenses).

According to some embodiments, a reserved expense amount or incurred expense amount includes paid and outstanding expense amounts. In one example, if the incurred amount is less than the paid amount, then the incurred amount is set equal to the paid amount. Similarly, in another example, if a claim is closed, the incurred amount is set equal to the paid amount.

According to some embodiments, a total paid amount comprises a sum of a prior paid expense amount paid by a previous carrier for claimant losses, a prior paid claim indemnity amount paid when claim was taken over from another carrier, a paid expense amount paid by a current carrier for claimant losses, and/or a paid medical amount paid by a current carrier for claimant losses.

In accordance with some embodiments, the claim history table 344b may comprise, alternatively or in addition, one or more of:
an outstanding claim and medical amount field that indicates a difference between a total incurred expense amount and a total paid amount for a corresponding claim;
a prior paid expense amount field that indicates the expense paid dollars when the claim was taken over from another carrier;
a paid expense amount field that indicates expense dollars that were paid by a carrier for claimant losses;
a subrogation amount field that indicates a lien recovery amount associated with a claim (e.g., based on a third party tort recovery);
a paid medical amount field that indicates an amount of medical expenses paid by a carrier for claimant losses;
a financial state code field that indicates a state (or other type of jurisdiction) for billing purposes;
an outstanding expense amount field that indicates a difference between a total incurred expense amount and a total paid expense amount for a corresponding claim;
an accident date field that indicates a date an accident related to a corresponding claim occurred;
a prior paid medical amount field that indicates an amount of medical expenses paid when a corresponding claim was taken over from another carrier;
a prior paid claim amount field that indicates an amount of indemnity paid when a corresponding claim was taken over from another carrier;
an outstanding medical amount field that indicates a difference between a total incurred medical amount and a total paid medical amount for a corresponding claim;
a policy effective date that indicates an effective date of a corresponding insurance policy;
a total outstanding amount field that indicates a sum of a total outstanding medical amount and a total outstanding expense amount associated with a corresponding claim;
an adjusting office code field that indicates a code (e.g., a unique identifier) that identifies an adjusting office associated with a corresponding claim;
a claim type field that indicates a type of a corresponding claim;
a total incurred amount field that indicates a total reserved amount including claim, medical, and/or expense dollars (e.g., for a corresponding claim; for a corresponding insurance line);
an incurred medical amount field that indicates a total amount of reserved medical dollars;
a total paid amount field that indicates a sum claim, medical, and/or expense dollars for a corresponding claim;
a paid claim and medical amount field that indicates a total of paid claim (indemnity) and medical dollars for a corresponding claim;
an outstanding claim amount field that indicates a difference between a total claim amount and an incurred claim amount corresponding to a claim;
a total claimants count field that indicates a total number of claimants associated with a claim;
a paid claim amount field that indicates an amount paid by a carrier for claimant losses;
a total outstanding amount field that indicates a difference between incurred and paid dollars;
a close date field that indicates a date that a complete claim filed corresponding to a claim was closed; and/or
an accident state code field that indicates a state (or other type of jurisdiction) in which an accident occurred (e.g., a unique identifier that identifies a state).

The comp table 344c may comprise, in accordance with some embodiments, a claim ID field 344c-1 that includes an identifier that uniquely identifies a claim, an injury type code field 344c-2 that indicates an identifier that identifies a type of injury, a body part code field 344c-3 that includes an identifier (e.g., a National Correct Coding Initiative (NCCI) body part code) that identifies a body part injured on a claimant (e.g., an injured worker), an accident cause code field 344c-4 that includes an identifier (e.g., NCCI accident cause code) that identifies a cause of an accident associated with a corresponding claim, a job class code field 344c-5, that includes an identifier that identifies an injured employee's job class, a loss code field 344c-6 that indicates whether a workers compensation claim is for lost time, medical expenses, or both, a severity code field 344c-7 that indicates a severity of a claim, a hire date field 344c-8 that indicates a date of hire of a corresponding claimant, a notify date field 344c-9, a days restricted field 344c-10 that indicates a number of days a claimant (e.g., an injured employee) is restricted from work, a days lost field 344c-11 that indicates a number of days a claimant missed work, a light duty availability field 344c-12 that indicates whether or not a light duty job is available to a claimant, a recurring injury field 344c-13 that indicates whether a claimant has a repetitive or recurring injury, and/or a pre-existing condition field 344c-14 that indicates whether a claimant has a pre-existing condition.

In accordance with some embodiments, the comp table 344c may comprise, alternatively or in addition, one or more of:
a primary diagnosis code field that includes an identifier that identifies a claimant's injury or illness;
a secondary diagnosis code field that includes an identifier that identifies a claimant's injury or illness;
a number of weeks for salary continuation field that indicates for a corresponding claim how many weeks a claimant is entitled to salary continuation;
a number of work days per week field that indicates a number of days per week that an employee normally works;
an occupation description field that includes a description of an injured employee's job;
an employer reimbursement indicator field that indicates whether an employer is reimbursed for workers compensation benefits paid when there is a salary continuance agreement;
a salary continuation indicator field that indicates, for a particular claim, whether or not the claimant is entitled to salary continuation;
a date employer notified of injury field that indicates a day an employer was notified by an injured employee of an injury;
a remaining weeks for salary continuance field that indicates for a particular claim how many weeks a claimant has remaining of his salary continuation;
a benefit state code field that indicates a state (or other jurisdiction) whose laws control a benefit level of a corresponding claim (e.g., for workers compensation claims);
a workers compensation case number that indicates a state-assigned case number for a workers compensation claim;
an average weekly wage amount field that indicates an average weekly dollar amount earned by an injured employee (e.g., for workers compensation claims);
a number of daily work hours field that indicates a number of hours per day that an employee normally works;
a birth date field that indicates a date of birth of a claimant or injured employee;
an injury result code that identifies the nature of an injury (e.g., an NCCI injury result code); and/or
a compensation rate field that indicates an amount of money that an injured employee is being paid weekly as a result of a work-related injury or illness.

The claims table 344d may comprise, in accordance with some embodiments, a claim ID field 344d-1, an accident code field 344d-2, an accident result code field 344d-3, an account number field 344d-4, a litigation flag field 344d-5, an accident year field 344d-6, a claim status code field 344d-7, a triage flag field 344d-8, a property damage field 344d-9, a body part field 344d-10, a cause field 344d-11, a first aid field 344d-12, an accident time field 344d-13, a lost time field 344d-14, a claimant count field 344d-15, a property damage count field 344d-16, and/or a catastrophe code field 344d-17.

In accordance with some embodiments, the claims table 344d may comprise, alternatively or in addition, one or more of the following example types of information, described by reference to an example descriptive business name, data item definition, and data item name:

| Descriptive Business Name | Data Item Name | Data Item Definition |
|---|---|---|
| TOTAL PRIOR PAID AMOUNT | TOT_PRIOR_PD_AMT | This is a computed field derived |
| | | by adding PRI_PD_CLM_AMT, |
| | | PRI_PD_MED_AMT and |
| | | PRI_PD_EXP_AMT. |
| CRAT Table Code | CRAT_TABLE_CD | For a customer, this field may |
| | | identify which of the CRAT |
| | | (Cause, Result, Agency and |
| | | Type) tables must be accessed |
| | | for information. |
| Free Area | FREE_AREA | This field captures the answers |
| | | to a set of customized field |
| | | questions. |
| Program Code | PGM_CD | A code which groups together |
| | | certain businesses (e.g., for |
| | | pricing purposes). |
| File Prefix Code | FL_PRFX_CD | Specifies the claim type. |
| Close Date | CLOSE_DT | The original date that the |
| | | complete claim file was closed. |
| Outstanding Claim & Medical | OUT_CLM_MED_AMT | The difference of incurred minus |
| Amount | | paid dollars. This field is |
| | | calculated by subtracting the |
| | | PD_CLM_MED_AMT from the |
| | | INCUR_CLM_MED_AMT. |
| Primary Individual Name | PRIMARY_INDV_NM | This is the individual who is the |
| (Claimant Name) | | primary on the Claim. The name |
| | | is either the claimant name (or if |
| | | an auto claim it is the driver |
| | | name). |
| Prior Paid Claim Amount | PRI_PD_CLM_AMT | This represents the indemnity |
| | | paid dollars, at a previous point |
| | | in time, at the claim level. |
| Accident Cause Description | CAUS_DESC_HIER_CD | This code is used to determine |
| Hierarchical Code | | who or what can update the |
| | | accident cause description field. |
| Accident Result Code | RESULT_CD | A client defined field which |
| | | describes the result of an |
| | | accident. |
| Fifth Organization Level Value | ORG_LVL5_VALUE_CD | Represents the fifth level of the |
| | | customer's organization |
| Third Organization Level Value | ORG_LVL3_VALUE_CD | Represents the third level of the |
| | | customer's organization |
| Type Hierarchical Code | TYPE_HIER_CD | This code is used to determine |
| | | who or what can update the type |
| | | code field. |
| Account Number | ACCT_NBR | Account number. A field that |
| | | uniquely identifies a particular |
| | | customer. |
| Paid Medical Amount | PD_MED_AMT | Medical dollars that were paid by |
| | | the carrier for claimant losses, at |
| | | the claim level |
| Date Claim Reopened | ROPEN_DT | The date that a closed claim was |
| | | reopened by the claim |
| | | department |
| Litigation Indicator | LITG_IND | Specifies whether or not the |
| | | claim is in litigation. |
| Total Paid Amount | TOT_PAID_AMT | The total paid dollar on a claim |
| | | includes claim, medical and |
| | | expense dollars, at the claim |
| | | level. |
| Last Update ID | LST_UPDT_ID_CD | Identifies the last person or |
| | | program that inserted or |
| | | updated a row on this table. |
| Attorney Involvement Indicator | ATTY_INVLV_IND | Specifies whether the claimant's |
| | | attorney is involved with the |
| | | claim; does not mean |
| | | necessarily mean that a suit has |
| | | been filed. |
| Caller Name | CALLER_NM | The name of the person who |
| | | reported the claim (e.g., for WC |
| | | claims only) |
| Fifth Lag Period | FTH_LAGPRD_DY_NBR | The number of calendar days |
| | | between the disability start date |
| | | and the first disability payment. |
| Accident Long Description | LONG_DESC_HIER_CD | This code is used to determine |
| Hierarchical | | who or what can update the |
| Code | | accident long description field. |
| Claim Handler's Initials | CLM_HNDL_ID | The initials of the person in the |
| | | claim office who is handling the |
| | | claim. |
| Outstanding Expense Amount | OUT_EXP_AMT | The difference of incurred minus |
| | | paid dollars. This field is |
| | | calculated, for example, by |
| | | subtracting the PD_EXP_AMT |
| | | from the INCUR_EXP_AMT. |
| Customer Alias Short Name | CUST_ALIAS_NM | A short name for a particular |
| | | customer |
| Litigation Paid Expense Amount | LITG_PD_EXP_AMT | The portion of the expense |
| | | dollars that was paid for litigation |
| | | including court costs, legal fees |
| | | and disbursements, at the claim |
| | | level. |
| Accident Year | ACC_YR | The calendar year in which the |
| | | accident occurred. |
| Subrogation Amount | SUBROGATION_AMT | Subrogation Amount, at the |
| | | claim level. |
| Agency Hierarchical Code | AGENCY_HIER_CD | This code is used to determine |
| | | who or what can update the |
| | | agency code field. |
| Policy Number | POL_NBR | The high level part of a policy's |
| | | unique identifier. |
| NURSE TRIAGE ACTIVITY | NURSE_TRIAGE_DT | The date the claimant received |
| DATE | | Nurse Triage Services. |
| Principal Claimant Number | PRINCIPAL_CLMT_NBR | This is the primary claimant |
| | | captured on the Claim. This field |
| | | may be useful, for example, in a |
| | | process where the Claim and |
| | | Claimant table must be joined. |
| | | Because a Claim can have |
| | | multiple claimants, this field |
| | | prevents the financials from |
| | | being miscalculated. |
| First Organization Level Value | ORG_LVL1_VALUE_CD | Represents the first level of the |
| | | customers organization |
| Date Entered in Financial | ENTRY_DT | The day the claim information |
| System | | was entered in a financial |
| | | system. |
| Claim Status Code | CLM_STS_CD | Specifies the status of the claim. |
| NURSE TRIAGE | NURSE_TRIAGE_TRANS_ID | A unique ID for claims going |
| TRANSACTION ID | | through Nurse Triage Services. |
| Paid Expense Amount | PD_EXP_AMT | Expense dollars that were paid |
| | | by the carrier for claimant |
| | | losses, at the claim level |
| Fourth Lag Period | FRTH_LAGPRD_DY_NBR | The number of calendar days |
| | | between the electronic claim |
| | | review and the date an injured |
| | | worker was contacted (e.g., for a |
| | | WC claim). |
| Outstanding Medical Amount | OUT_MED_AMT | The difference of incurred minus |
| | | paid dollars. This field may be |
| | | calculated by subtracting the |
| | | PD_MED_AMT from the |
| | | INCUR_MED_AMT. |
| Prior Paid Medical Amount | PRI_PD_MED_AMT | This represents the medical paid |
| | | dollars, at a previous point in |
| | | time, at the claim level. |
| Last Update Date & Time | LST_UPDT_TIMESTAMP | Specifies the Date and Time that |
| | | the last insert or update was |
| | | made on this table |
| Second Lag Period | SEC_LAGPRD_DY_NBR | The number of calendar days |
| | | between the date the claim was |
| | | reported to the employer and the |
| | | date it was received by the |
| | | insurer. |
| Adjusting Office Code | ADJ_OFC_CD | The code of the office handling |
| | | the claim. |
| Agency Code (Part of Body) | AGENCY_CD | A client defined field that |
| | | specifies, for a particular claim, |
| | | which part of the body was |
| | | injured. |
| CB TO CM TRANSFER DATE | CB_TO_CM_TRANSFER_DT | The date a claim went from CB |
| | | to CM. |
| SUPPLEMENTAL CAUSE OF | SUPPL_CAUSE_OF_LOSS_IND | An indicator identifying whether |
| LOSS INDICATOR | | supplemental loss coding was |
| | | done on a claim by the Claim |
| | | Department. |
| NURSE TRIAGE INDICATOR | NURSE_TRIAG_IND | Indicates whether the claim has |
| | | gone through Nurse Triage |
| | | services. If a claim has a |
| | | Transaction ID, then set |
| | | indicator to Y, else set to N. |
| CATASTROPHE CODE | CATASTROPHE_CD | A code identifying a particular |
| | | catastrophe or disaster. The |
| | | value is assigned using an |
| | | industry supported code |
| Policy Year | POL_YR | The year in which the policy |
| | | became effective. This is the |
| | | year a claim is charged against |
| Outstanding Claim Amount | OUT_CLM_AMT | The difference of incurred minus |
| | | paid dollars. This field may be |
| | | calculated by subtracting the |
| | | PD_CLM_AMT from the |
| | | INCUR_CLM_AMT. |
| Date Notice Received | NOL_DT | The date the field office received |
| | | notice of the claim and entered it |
| | | into the claim management |
| | | system. |
| Organization Code | ORG_CD | A code which designates the |
| | | business unit, in the |
| | | organization, responsible for the |
| | | loss. This structure is defined by |
| | | the customer |
| System Generated Claim | CLM_SYS_ASGN_ID | A system generated number |
| Number | | which uniquely identifies a claim. |
| Notice of Loss Year | NOL_YR | The calendar year in which the |
| | | accident was reported. |
| Total Claimant Count | TOT_CLMT_CNT | The total number of claimants |
| | | associated with the claim, at the |
| | | claim level. |
| Sixth Lag Period | SXTH_LAGPRD_DY_NBR | The number of calendar days |
| | | between the Notice of Loss date |
| | | and Accident date. |
| SUBSIDIARY ADDRESS | SUBSIDIARY_ADDRESS | Street address of accident |
| | | location. |
| CM TO CB TRANSFER DATE | CM_TO_CB TRANSFER_DT | The date a claim went from CM |
| | | to CB |
| Number of Claimants with Bodily | BI_CLMT_CNT | For a claim, the total number of |
| Injury | | claimants with Bodily Injury. |
| Organization Code Hierarchical | ORG_HIER_CD | This code is used to determine |
| Code | | who or what can update the org |
| | | code field. |
| Major Line Code | MAJ_LN_CD | This is the first position of |
| | | INS_LINE_CD. |
| Subrogation Indicator | SUBRO_IND | Specifies whether or not the |
| | | claim was or is in subrogation. |
| Accident Date | ACC_DT | The date the accident occurred. |
| Incurred Claim Amount | INCUR_CLM_AMT | The total reserved claim |
| | | (indemnity) dollars. Incurred |
| | | dollars include paid and |
| | | outstanding, at the claim level. If |
| | | incurred is less than paid, then |
| | | incurred may be set equal to |
| | | paid. If claim is closed, incurred |
| | | may be set equal to paid. |
| Incurred Expense Amount | INCUR_EXP_AMT | The total reserved expense |
| | | dollars. Incurred dollars include |
| | | paid and outstanding, at the |
| | | claim level If incurred is less |
| | | than paid, then incurred may be |
| | | set equal to paid. If claim is |
| | | closed, incurred may be set |
| | | equal to paid. |
| Other Carrier CRAT Code | OCD_CRAT_CD | The incoming CRAT code on |
| | | Other Carrier Data. |
| Third Lag Period | THRD_LAGPRD_DY_NBR | The number of calendar days |
| | | between the date it was received |
| | | by the carrier and the electronic |
| | | claim review date. The electronic |
| | | claim review date is, e.g., the |
| | | first time the claim is reviewed |
| | | on the carrier's claim system |
| Property Damage Claimant | PROPDMG_CLMT_CNT | For a claim, the total number of |
| Count | | claimants with Property |
| | | Damage, at the claim level |
| Incurred Claim & Medical | INCUR_CLM_MED_AMT | The total reserved claim |
| Amount | | (indemnity) plus medical dollars. |
| | | Incurred dollars include paid and |
| | | outstanding, at the claim level. If |
| | | incurred is less than paid, then |
| | | incurred may be set equal to |
| | | paid. If claim is closed, incurred |
| | | may be set equal to paid. |
| Notice Source Code | NTC_SOURCE_CD | Identifies the method used to |
| | | report the claim. |
| Controverted Claim Indicator | CNTV_CLM_IND | An indicator specifying whether |
| | | or not the claim has been |
| | | denied. |
| Carrier Code | CARRIER_CD | The organization responsible for |
| | | the payment of the claim. |
| Accident Result Hierarchical | RESULT_HIER_CD | This code is used to determine |
| Code | | who or what can update the |
| | | result code field. |
| First Lag Period | FST_LAGPRD_DY_NBR | The number of calendar days |
| | | between the date of loss and the |
| | | date the claim was reported to |
| | | the employer. |
| Paid Claim Amount | PD_CLM_AMT | Claim dollars that were paid by |
| | | the carrier for claimant losses, at |
| | | the claim level |
| Liability Accident Cause Code | NON_COMP_CAUS_CD | A standardized cause coding |
| | | structure for liability claims |
| Legal Disbursement Amount | LEGAL_DISBURS_AMT | The amount owed for legal |
| | | disbursements, at the claim |
| | | level. |
| Legal Fee Amount | LEGAL_FEE_AMT | The amount owed for legal fee |
| | | services, at the claim level. |
| Major Line Category Code | MAJ_LN_CATG_CD | High level insurance coverage |
| | | categories. |
| Accident Result Hierarchical | RSLT_DESC_HIER_CD | This code is used to determine |
| Code | | who or what can update the |
| | | accident result description field. |
| Accident State Code | ACC_ST_CD | The state where the accident |
| | | occurred. |
| Fourth Organization Level Value | ORG_LVL4_VALUE_CD | Represents the fourth level of |
| | | the customer's organization |
| Claim Management Status Code | CLM_MGMT_STS_CD | Specifies the status of the claim. |
| | | This status is based on the |
| | | claim's administration process. |
| Type Code | TYPE_CD | A client defined field which is |
| | | used to identify the type of |
| | | accident. |
| Accident Result | ACC_RSLT_DESC | The text describing the actual |
| | | result of the accident. |
| Policy Form Code | POL_FM_CD | Part of the identifier which |
| | | specifies the type of policy. |
| Total Incurred Amount | TOT_INCURRED_AMT | This is the total reserved dollars |
| | | on a claim; includes claim, |
| | | medical and expense dollars. |
| | | Incurred dollars include paid and |
| | | outstanding, at the insurance |
| | | line (INS.LINE) level |
| EMPLOYEE STREET | EMPLOYEE_ADDRESS | Street home address of injured |
| ADDRESS | | employee. |
| Refinal Date(Last Date Claim | RFNL_DT | The last date that the claim was |
| Closed) | | closed. The ECR RFNL_DT will |
| | | equal the CLOSE_DT if the |
| | | claim was never re-opened. |
| Customer's Reporting Year | REPORT_YR | This year defines how the |
| | | customer wants claim reporting. |
| | | It is usually based on the |
| | | calendar year or policy year in |
| | | which the accident occurred, |
| | | however the customer may have |
| | | this field pertain to any year: |
| | | ACC_YR, NOL_YR, POL_YR, |
| | | FISCAL_YR, etc. |
| Accident Description Long Text | ACC_LONG_DESC | A description about an accident |
| | | (e.g., obtained from a phone call |
| | | by a caller to a 1-800 phone line |
| | | to report an accident or claim). |
| Cause Code Hierarchical Code | CAUS_OF_LS_HIER_CD | This code is used to determine |
| | | who or what can update the |
| | | cause of loss field. |
| Second Organization Level | ORG_LVL2_VALUE_CD | Represents the second level of |
| Value | | the customer's organization |
| Paid Claim & Medical Amount | PD_CLM_MED_AMT | The total paid claim(indemnity) |
| | | and medical dollars on a claim, |
| | | at the claim level |
| Accident Cause | CAUS_OF_LS_CD | A client defined field which |
| | | describes the cause of the |
| | | accident. |
| Policy Effective Date | POL_EFF_DT | The first day that the policy is |
| | | effective. |
| Incurred Medical Amount | INCUR_MED_AMT | The total reserved medical |
| | | dollars. Incurred dollars include |
| | | paid and outstanding, at the |
| | | claim level. If incurred is less |
| | | than paid, then incurred may be |
| | | set equal to paid. If claim is |
| | | closed, incurred may be set |
| | | equal to paid. |
| CAUSE OF LOSS LEVEL 1 | CAUSE_OF_LOSS_LVL1_CD | Primary Event. |
| CODE | | |
| CAUSE OF LOSS LEVEL 4 | CAUSE_OF_LOSS_LVL4_CD | Other contributing factor. |
| Financial State Code | FNCL_ST_CD | Two character state |
| | | abbreviation. The meaning of |
| | | state will vary depending on line |
| | | of business. WC may use |
| | | benefit state; one or more other |
| | | lines may use other states (e.g., |
| | | accident state). |
| Other Carrier Organization Code | OCD_ORG_CD | Other Carrier Organization |
| | | Code. A code which designates |
| | | the business unit, in the |
| | | organization, responsible for the |
| | | loss. The organization structure |
| | | and this organization code may |
| | | be defined by the customer. |
| CAUSE OF LOSS LEVEL 2 | CAUSE_OF_LOSS_LVL2_CD | More detail Event. |
| CAUSE OF LOSS LEVEL 3 | CAUSE_OF_LOSS_LVL3_CD | Alleged contributing factor. |
| Telephone Reported Indicator | RPT_IND_1_800 | Specifies whether or not the |
| | | claim was reported through a |
| | | telephone hotline. |
| Accident Time | ACC_TM | The time of day in which the |
| | | accident occurred. |
| Claim Number | CLM_NBR | A unique number assigned to |
| | | each accident or injury. |
| CAUSE OF LOSS LEVEL 5 | CAUSE_OF_LOSS_LVL5_CD | Labor law cited. |
| EMPLOYEE ID | EMPLOYEE_ID | A unique identifier, such as a |
| | | social security number (SSN) or |
| | | other type of unique identifier in |
| | | lieu of SSN. |
| EMPLOYEE DEPARTMENT | EMPLOYEE_DEPT_NM | Name of department where |
| NAME | | injured employee worked. |
| FIRST AID INDICATOR | FIRST_AID_IND | An indicator that would identify |
| | | whether the injured worker |
| | | received First Aid (in house). |
| INJURED WORKER'S TOWN | EMPLOYEE_CITY | The town where the injured |
| ADDRESS | | worker lives at time of accident. |
| EMPLOYEE ZIP CODE | EMPLOYEE_ZIP_CD | The Zip Code address of injured |
| | | employee at time of accident. |
| Prior Paid Expense Amount | PRI_PD_EXP_AMT | This represents the expense |
| | | paid dollars, at a previous point |
| | | in time, at the claim level. |
| STATE WHERE INJURED | EMPLOYEE_STATE_CD | The State where the injured |
| EMPLOYEE RESIDES | | worked lived at time of accident. |
| DEPARTMENT NAME WHEN | DEPT_WHEN_INJURED_NM | Name of the department where |
| INJURED | | employee was injured. |
| Total Outstanding Amount | TOT_OUTSTNDING_AMT | The difference of incurred minus |
| | | paid dollars. This field may be |
| | | calculated by adding together |
| | | the OUT_CLM_MED_AMT and |
| | | the OUT_EXP_AMT. |
| Free Area Hierarchical Code | FREE_AREA_HIER_CD | This code may be used to |
| | | determine who or what can |
| | | update the free area field. |
| COMPENSATION BEGIN DATE | COMPENSATION_BEGIN_DT | This is the same date as |
| | | Disability Begin Date. |
| ORG LEVEL CODES 1 & 2 & 3 | ORG_LVL123_VALUE_CD | See Org Levels for definition. |
| | | Combines Org. Level 1 & 2 & 3 |
| ORG LEVE 1 & 2 & 3 & 4 | ORG_LVL1234_VALUE_CD | See Org Levels for definition. |
| | | Combines Org. Level 1 & 2 & 3 |
| | | & 4 |
| ORG LEVEL 1 & 2 | ORG_LVL12_VALUE_CD | See Org Levels for definition. |
| | | Combines Org. Level 1 & 2 |
| OSHA INDICATOR | OSHA_CASE_ON_LOG_IND | Identifies where the claim is |
| | | OSHA recordable or not. |
| SUBTYPE INDICATOR | SUBTYPE_IND | An identifier of Benefit |
| | | Management and Maintenance |
| | | only Claims. Values are: 1 - |
| | | Lifetime Indemnity Only 2 - |
| | | Lifetime Medical Only - stable 3 - |
| | | Lifetime Ind & Med - stable 4 - |
| | | Companion Claim 5 - Inactive |
| | | O.D. or C.T. 6 - Permanency |
| | | Waiting Period 7 - Subro Only 8 - |
| | | Lien Issues Only 9 - Awaiting |
| | | Offsets Reimbursements A - |
| | | Death Benefits B - Payment of |
| | | Award Only (TTD, PPD, PTD) C - |
| | | Lifetime Med/Ind Cap D - |
| | | Lifetime Medical Only - active E - |
| | | Lifetime Ind & Med - active F - |
| | | Asbestos Benefit Management |
| | | values are 1, 2, 3, A, B, C, D, E. |
| | | Maintenance Only values are |
| | | 4, 5, 6, 7, 8, 9, F. |
| SUBSIDIARY ADDRESS | SUBSIDARY_ZIP_CD | Zip Code of Accident location. |
| LOST TIME INDICATOR | LOST_TIME_IND | An indicator that would identify |
| | | whether the injured worker lost |
| | | time from work. |
| SUBSIDIARY ADDRESS | SUBSIDIARY_STATE_CD | State abbreviation of Accident |
| | | location. |
| SUBSIDARY ADDRESS | SUBSIDARY_CITY | City of accident location. |
| Incident Indicator | INCIDENT_IND | A claim is considered an incident |
| | | only file and defaults to “Y” (Yes) |
| | | when the loss designator is CM, |
| | | there are no indemnity, medical |
| | | or expense payments and there |
| | | are no operator notes input by |
| | | the adjusting field office (AFO). |
| | | Otherwise, the system defaults |
| | | to “N”. |
| SERIOUS INJURY INDICATOR | SERIOUS_INJURY_IND | An indicator that identifies a |
| | | Serious Injury. |

In accordance with some embodiments, a workers compensation table or other type of data store (not shown) may comprise one or more of the following example types of information, described by reference to an example descriptive business name, data item definition, and data item name:

| Descriptive | | |
|---|---|---|
| Business Name | Data Item Name | Data Item Definition |
| Light Duty | LGHT_DUTY_AVAL_IND | Specifies whether or not a light duty job is |
| Available | | available for the claimant. |
| Indicator | | |
| Primary | DIAG1_CODE | This is the primary industry standard code that |
| Diagnosis Code | | identifies the claimant's injury or illness. |
| Injury Type Code | INJ_TYPE_CD | Defines the type of injury. |
| Last Update Date | LST_UPDT_TIMESTAMP | Specifies the Date and Time that the last insert |
| & Time | | or update was made on this table |
| Job Class | JOB_CLASS_HIER_CD | This code is used to determine who or what can |
| Hierarchical | | update the job class field. |
| Code | | |
| Number of | SALCONT_ENTITL_WKS | Specifies, for a particular claim, how many |
| Weeks for Salary | | weeks a claimant is entitled to salary |
| Continuance | | continuation. |
| Number of Work | NBR_WEEKLY_WRKDAYS | The number of days, per week, that an |
| Days Per Week | | employee normally works. |
| Loss Designator | LS_DESG_CD | Identifies whether WC claims are lost time or |
| Code | | medical only. |
| Date of Hire | EE_HIRE_DT | The date in which the employee was hired. |
| Contact Date | CONTACT_DT | The day the injured employee was contacted. |
| Workers | WC_CUM_INJ_IND | Workers Compensation Cumulative Injury. A |
| Compensation | | Yes/No Indicator specifying whether or not this |
| Cumulative Injury | | claimant has a repetitive/reoccurring injury. |
| Customer Alias | CUST_ALIAS_NM | A short name for a particular customer. |
| Short Name | | |
| Current Qualifier | CURR_QUALIFIER_CD | Reflects the QUALIFIER_CD_ID on the latest |
| Code | | row of the ECR_RTW_ACTV table. |
| Total Lost Days | TOTAL_LOST_DAYS | The number of days that the claimant missed |
| | | from work |
| Occupation | OCCUPATION_DESC | Description of the injured employee's job. |
| Description | | |
| Last Update ID | LST_UPDT_ID_CD | Identifies the last person or program that |
| | | inserted or updated a row on this table. |
| Job Class Code | JOB_CLASS_CD | A code which identifies an injured employee's |
| | | job class |
| Employer | EMPLYR_REIMB_IND | Indicates whether an employer is reimbursed |
| Reimbursement | | for workers compensation benefits paid when |
| Indicator | | there is a salary continuance agreement. |
| Salary | SALARY_CONTINU_IND | Specifies, for a particular claim, whether or not |
| Continuation | | the claimant is entitled to salary continuation. |
| Indicator | | |
| Date Employer | EMPLYR_NTFY_DT | The day the employer was notified by the |
| Notified of Injury | | injured employee. |
| Remaining | SALCONT_REMAIN_WKS | Specifies for a particular claim how many weeks |
| Weeks for Salary | | a claimant has remaining of his or her salary |
| Continuance | | continuation. |
| NCCI Body Part | NCCI_BODY_PART_CD | The NCCI code used to represent the part of |
| Code | | body injured on the employee. |
| Benefit State | BENEFIT_ST_CD | The state whose laws are controlling the benefit |
| Code | | level of the claim. Available for WC claims only. |
| Occupation | OCCUP_DESC_HIER_CD | This code is used to determine who or what can |
| Description | | update the occupation description field. |
| Hierarchical | | |
| Code | | |
| System | FK_CLM_SYS_ASGN_ID | A system generated number which uniquely |
| Generated Claim | | identifies a claim. |
| Number | | |
| Workers | WC_CASE_NBR | The state assigned Workers Compensation |
| Compensation | | case number that is used when filing forms and |
| Case Number | | referring to the claim within the state. |
| Secondary | DIAG2_CODE | This is the secondary industry standard code |
| Diagnosis Code | | that identifies a claimant's injury or illness. |
| NCCI Accident | NCCI_CAUSE_CD | The NCCI code used to identify the nature of |
| Cause Code | | the accident. |
| Average Weekly | AVG_WK_WG_AMT | The average weekly dollar amount earned by |
| Wage Amount | | the injured employee. Available for WC claims |
| | | only. |
| Number of Daily | NBR_DAILY_WRKHRS | The number of hours, per day, that the |
| Work Hours | | employee normally works. |
| Birth Date | BIRTH_DT | The birth date of the claimant/injured employee. |
| Days Restricted | DAY_RSTRC_FROM_WRK | The number of days restricted from work. |
| From Work | | |
| NCCI Injury | NCCI_RESULT_CD | The NCCI code that identifies the nature of the |
| Result Code | | injury. |
| Compensation | COMP_RT | Compensation Rate. The amount of money that |
| Rate | | an injured employee is being paid weekly as a |
| | | result of a work related injury or illness. |
| PRE EXISTING | PRE_EXISTING_COND_IND | An indicator identifying whether the claimant |
| CONDITION | | has a pre-existing condition. |
| INDICATOR | | |
| Claim Level | CLM_LEVEL_CD | Defines the severity of the claim. |
| (Severity) Code | | |

In accordance with some embodiments, a return to work table or other type of data store (not shown) may comprise respective fields for storing one or more types of claim information related to management of workers compensation claims (e.g., disability start date, duty type, amount of lost time).

In some embodiments, fewer or more data fields than are shown may be associated with the data tables 344a-d, the example workers compensation information, and/or the example return to work table. Only a portion of one or more databases and/or other data stores is necessarily shown in any of FIG. 3A and/or FIG. 3B or the above example tables, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

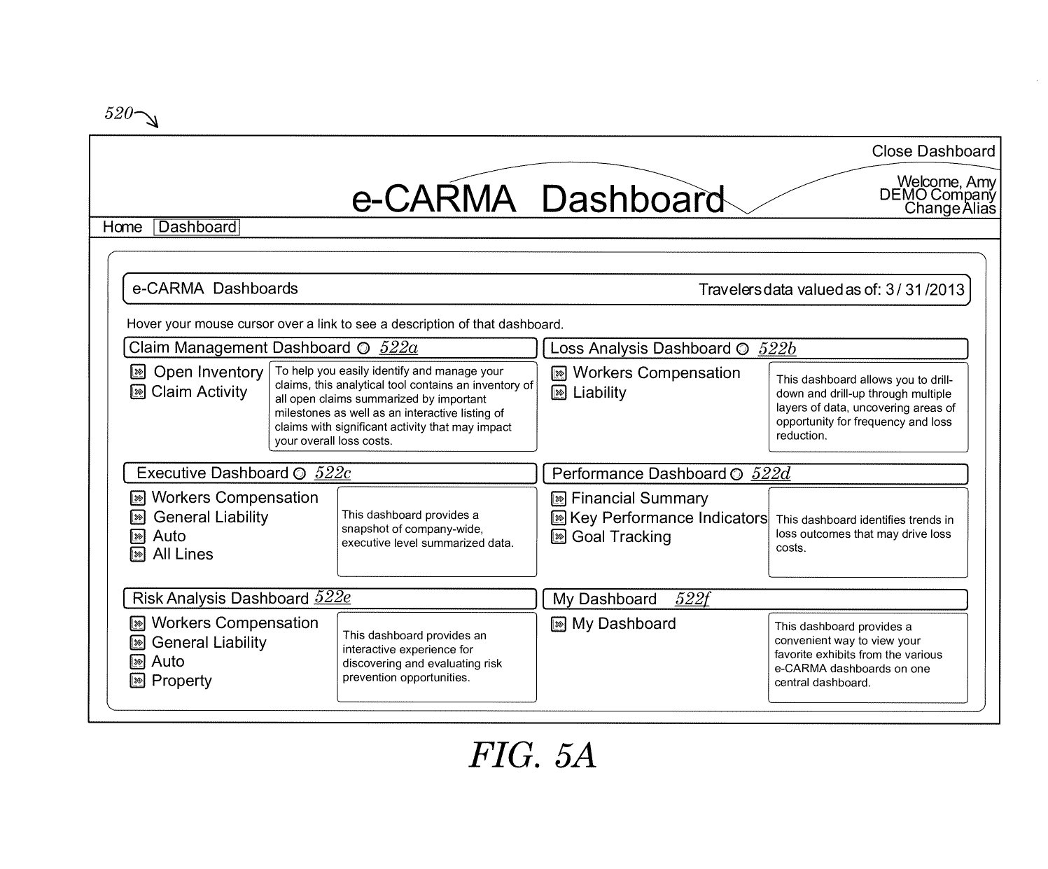

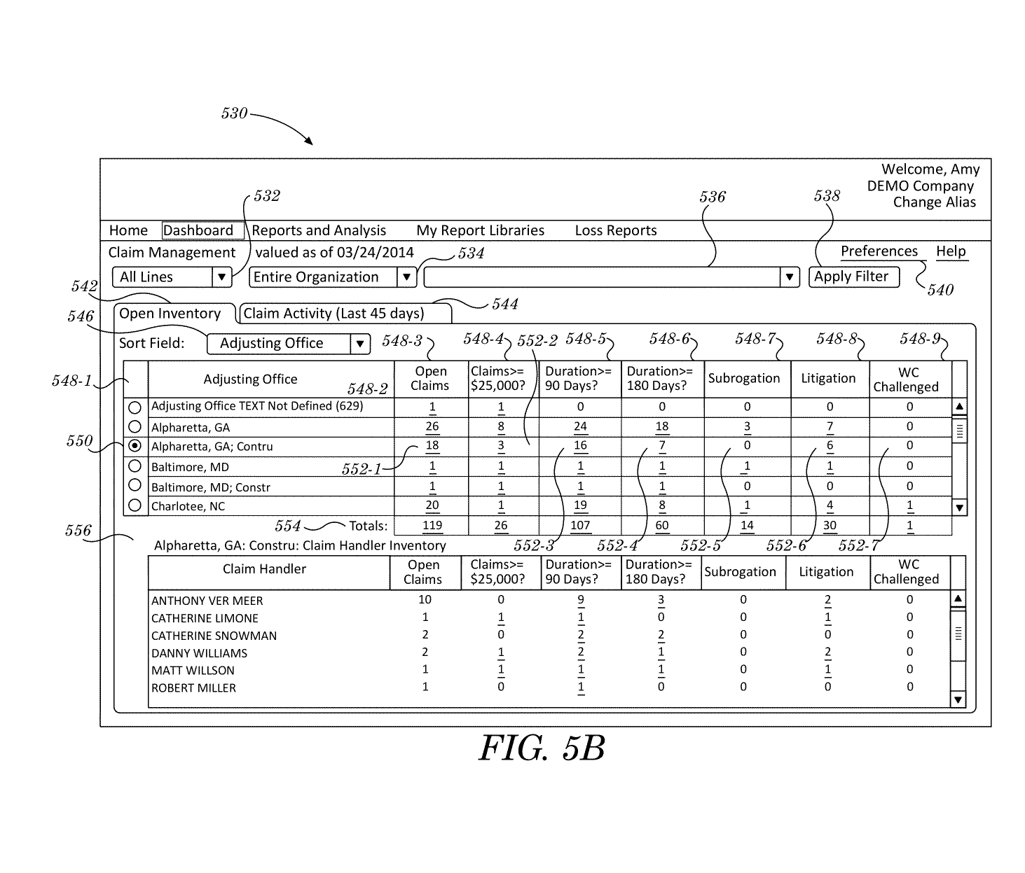

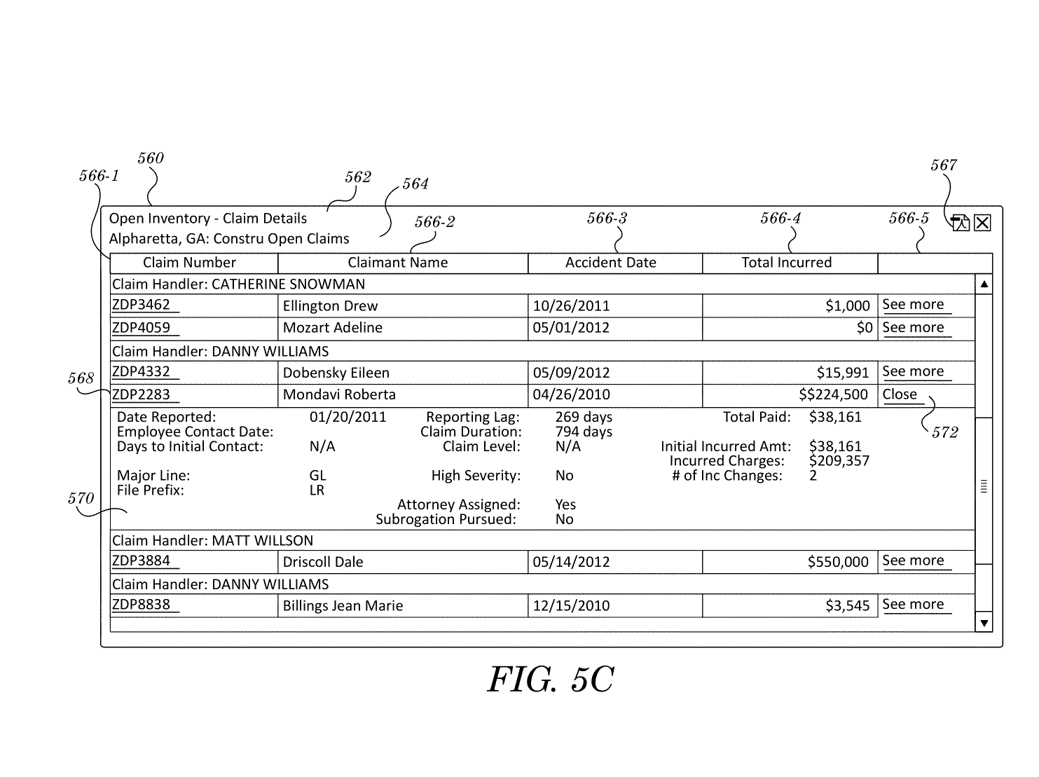

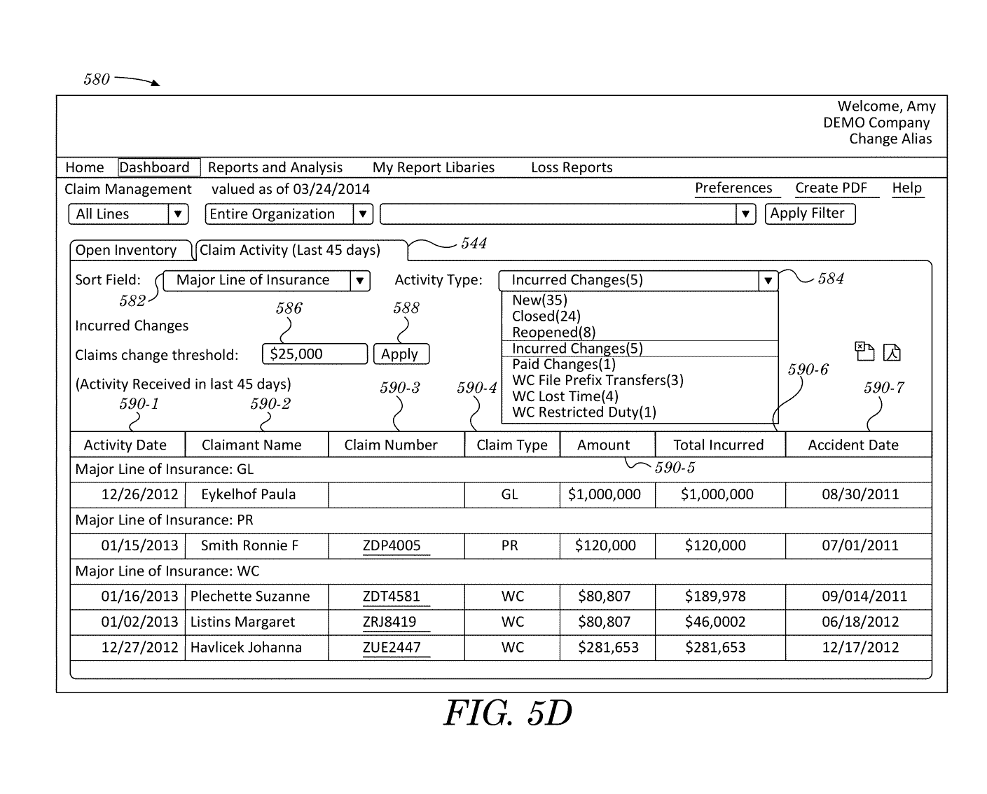

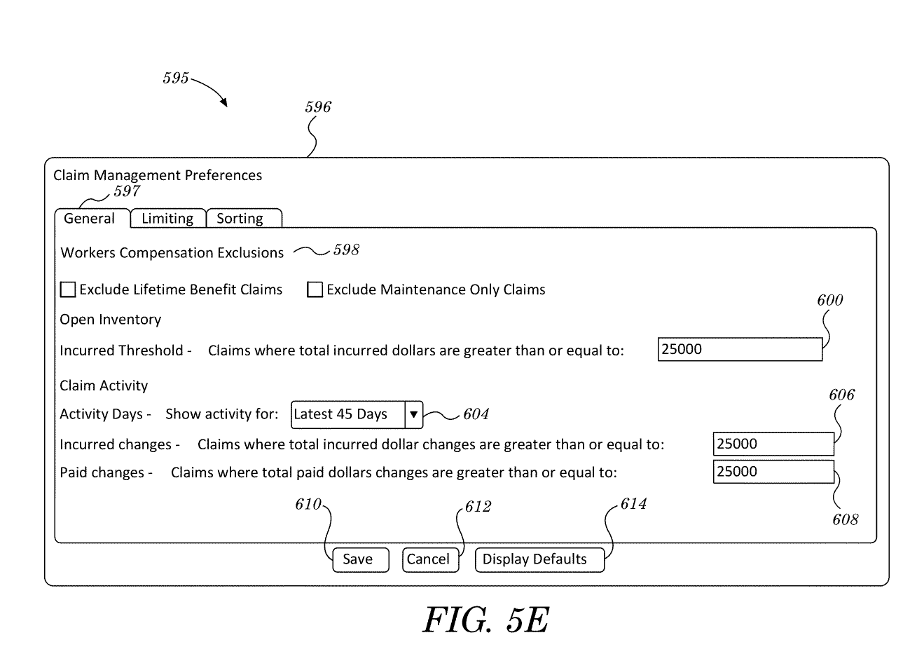

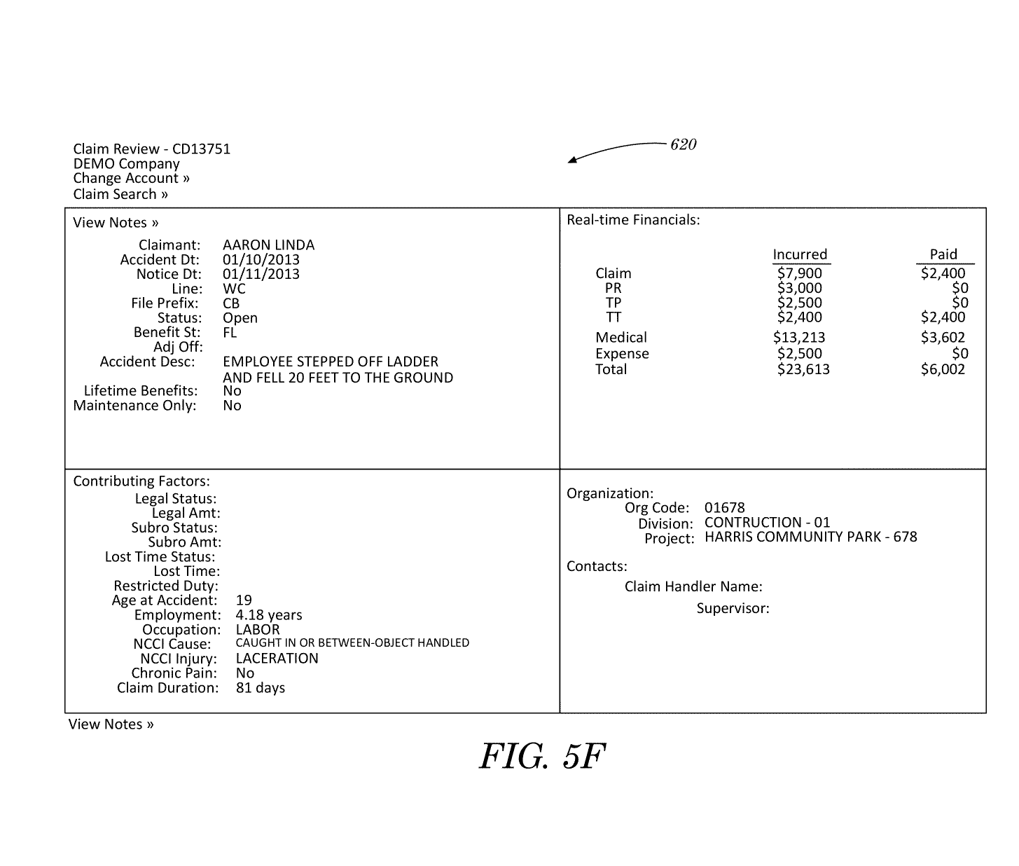

Turning to FIG. 4, a flowchart of a method 400 according to some embodiments is shown. In some embodiments, the method 400 may be performed and/or implemented by and/or otherwise associated with one or more specialized computerized processing devices, computers, computer terminals, and/or computer servers (e.g., the claim management server 110 of FIG. 1 and/or the processing layer 210 of FIG. 2), computer systems (e.g., the systems 100, 200 of FIG. 1 and/or FIG. 2, and/or any portions or combinations thereof) and/or networks (e.g., the network 104 of FIG. 1), and/or any portions or combinations thereof. In some embodiments, the method 400 may be embodied in, facilitated by, and/or otherwise associated with various input mechanisms and/or interfaces such as the interfaces 220, 520 described with respect to FIG. 2, FIG. 5A, FIG. 5B, FIG. 5C, FIG. 5D, FIG. 5E, and/or FIG. 5F herein. According to some embodiments, the method 400 may comprise a method for customer-driven claim management.

The functional diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Universal Serial Bus (USB) mass storage device, and/or DVD) may store thereon instructions that when executed by a machine (such as a computerized processing device) result in performance according to any one or more of the embodiments described herein.

In some embodiments, the method 400 may comprise determining claim information, at 402. For example, determining claim information may comprise one or more of: (i) identifying one or more open claims under an insurance policy (e.g., workers compensation claims) and/or (ii) identifying one or more opens claims having recent activity (e.g., in the last forty-five days). In some embodiments, recent activity may comprise a change in a claim's status (e.g., new, closed, or reopened), a change in the claim file type (e.g., a change from a medical only workers compensation claim (CM) to a workers compensation claim including other types of claim amounts (CB), a change in an amount incurred for a claim, a change in an amount paid for a claim, and/or a change in an employee's status (e.g., injured worker is now out of work or on restricted duty).

According to some embodiments, determining claim information at 402 may comprise determining claim information based on one or more data sources, databases, and/or data summary tables (e.g., generated in accordance with one or more stored procedures). Various data (e.g., as described herein) associated with a customer, a customer's associated claims, a customer's business, demographics, statistics, and/or other insurance-related data may be utilized to facilitate claim management by or for a customer. In some embodiments, such data (or any portion thereof, as is or becomes desirable and/or practicable) may exist and/or reside in a plurality of data stores, formats, and/or locations and/or may require knowledge of, access to, and/or utilization of various and/or differing electronic addresses, credentials, and/or other information.

In some embodiments, even if a customer had the appropriate knowledge, access, etc., the disparate and/or detailed nature of such data may require multiple complex and/or nested or iterative reports, queries, and/or analysis in order to gain an understanding of the customer's potential claim losses.

According to some embodiments, by creating one or more summary tables of selected portions of the available claim data associated with the customer, much of the expertise and work required to manage any open claims may be completed on behalf of the customer. Summary tables may, for example, allow or permit a customer to conduct simple queries that reveal important claim management decision-making metrics which would otherwise be too complex and/or time-consuming for the customer to conduct. According to some embodiments, one or more summary tables may be created, accessed, and/or otherwise determined based on claim information (e.g., accessed from a data source and/or database).

In some embodiments, in order to provide (e.g., via a user interface) a count of and/or access to details for certain claims for claim management, a particular summary table may, for example, summarize open claim data based on one or more of:
an adjusting office
a specific line of insurance
a specific claim handler
a number of open claims
a predetermined threshold claim amount (e.g., for providing a count of and/or access to details for all open claims having an associated claim amount greater than or equal to $25,000);
a predetermined threshold number of days claims have been open (e.g., for providing a count of and/or access to details for all claims open for at least 90 days, 180 days, etc.);
whether claims have related subrogation and/or litigation matters;
whether workers compensation claims have been challenged;
new claims (e.g., for providing a count of and/or access to details for recently opened claims);
closed claims (e.g., for providing a count of and/or access to details for recently closed claims);
reopened claims (e.g., for providing a count of and/or access to details for claims recently reopened);
incurred amounts (e.g., for providing a count of and/or access to details for claims with amounts recently incurred);
paid amounts (e.g., for providing a count of and/or access to details for claims with amounts recently paid);
a type of status change (e.g., for providing a count of and/or access to details for claims with recent status changes);
an indication of workers compensation lost time (e.g., for providing a count of and/or access to details for workers compensation claims recently updated with lost time for a corresponding injured employee); and/or
an indication of workers compensation restricted duty (e.g., for providing a count of and/or access to details for workers compensation claims recently updated to reflect a change in restricted duty status).

In some embodiments, the method 400 may comprise providing a claim management interface, at 404. The claim management interface may, for example, comprise a web page, website, Graphical User Interface (GUI), mobile device application, touch-screen application and/or interface, and/or any combinations thereof. According to some embodiments, the claim management interface may comprise a series of screen interface screens such as the example interfaces 220, 520, 530, 560, 580, 595, 620 described with respect to FIG. 2, FIG. 5A, FIG. 5B, FIG. 5C, FIG. 5D, FIG. 5E, and/or FIG. 5F. In some embodiments, the interface may be provided by transmitting (or causing a transmitting) of one or more signals and/or data to a device utilized by a customer/user. In some embodiments, the interface may be provided via provision of application software and/or other stored specially-programmed instructions (e.g., execution of which may cause a processing device to operate in accordance with embodiments described herein).

According to some embodiments, the method 400 may comprise receiving customer input via the claim management interface, at 406. A customer and/or other user may, for example, provide an indication of a customer/user selection of one or more parameters and/or metrics via the claim management interface provided at 404. In some embodiments, a server and/or other processing device may receive such an indication and/or input from a device operated by the customer/user. For instance, a user may select (e.g., by clicking on using a pointer device) a link associated with a count of open claims displayed via the claim management interface. According to some embodiments, the input may comprise an identification and/or definition of metric for which data presented by the claim management interface is to be summarized, filtered, ranked, sorted, and/or otherwise processed and/or provided or displayed.

According to one or more embodiments, a user and/or system may establish one or more preferences of interest to a user (e.g., for threshold amounts, periods of time for which to analyze claims, etc.). When one or more claims are identified meeting such criteria, the system may generate automatically an indication of such claims for a user (e.g., via an interface), a signal and/or alert, e.g., via email, text/SMS message, website and/or any other communications technology, to alert a carrier, customer, and/or insurance professional (e.g., a claim handler, an account executive) to indicate that the identified claim(s) should be reviewed (e.g., in a claim review process). In one example, detection of a claim that incurred a change in the amount paid out greater than a threshold criteria preference (e.g., set by a customer) for such a value may trigger an alert to the customer (e.g., via a claim management dashboard, email, or other communication means).

Referring now to FIG. 5A, FIG. 5B, FIG. 5C, FIG. 5D, FIG. 5E, and FIG. 5F, an example interface 520 according to some embodiments is shown. In some embodiments, the interface 520 may comprise a web page, web form, database entry form, Application Program Interface (API), spreadsheet, table, and/or application or other GUI, such as a smart phone application. The interface 520 may, for example, be utilized by a customer and may facilitate customer-driven claim management as described herein. The interface 520 may, for example, comprise portions of a customer-driven claim management application and/or platform programmed and/or otherwise configured to execute, conduct, and/or facilitate the method 400 of FIG. 4 and/or portions or combinations thereof. In some embodiments, the interfaces 520 may be output via one or more computerized devices such as the customer devices 102a-n of FIG. 1 herein.

According to some embodiments, the interface 520 (e.g., as shown in FIG. 5A), may comprise an interface screen that allows a customer to select a variety of available options. As depicted, for example, the interface 520 may provide an “e-CARMA Dashboard” that allows a customer/user to select from various categories of options, such as a Claim Management Dashboard 522a, a Loss Analysis Dashboard 522b, an Executive Dashboard 522c, a Performance Dashboard 522d, and/or a Risk Analysis Dashboard 522e. In some embodiments, the interface 520 may comprise a saved customer preference option such as My Dashboard 522f. The My Dashboard option 522f may, for example, provide a link to one or more of the other Dashboards 522a-e previously utilized and/or indicated as desirable by a customer/user. In some embodiments, selection of one or more of the specific Dashboards 522a-f may be filtered, refined, and/or narrowed, such as by selection of a particular type of information focus for the Claim Management Dashboard 522a (e.g., Open Inventory, Claim Activity). In some embodiments, selection of the Claim Management Dashboard 522a may cause another (e.g., different and/or modified) interface 520 to be displayed, generated, and/or otherwise provided.

According to one example implementation, the Claim Management Dashboard 522a of interface 520 of FIG. 5A may be useful for displaying critical information in an interactive and guided work flow to help customers, brokers, agents, internal employees of an insurance carrier and/or other types of customers successfully manage claims.

According to some embodiments, selection of the Claim Management Dashboard 522a of the interface 520 of FIG. 5A may cause the example interface 530 as depicted in FIG. 5B to be provided. In some embodiments, the interface 530 may comprise various drop-down menus (and/or other features) from which the customer/user may select summarization and/or filter options. The interface may comprise, for example, an insurance type selector 532, a filter level selector 534, a filter value selector 536 and/or a filter application button 538. The insurance type selector 532 may, according to some embodiments, comprise a drop-down menu (as depicted in FIG. 5B) that allows the customer to select one or more types of insurance for which data presented by the interface may be limited, summarized, and/or filtered (e.g., workers compensation, general liability, auto, property, and product liability lines). As shown in the example of FIG. 5B, the insurance type selector has been utilized to select “All Lines” of insurance.

The filter level selector 534 may, in some embodiments, comprise a drop-down menu (as depicted in FIG. 5B) that allows the customer to select a level of a customer's organization by which the data presented by the interface may be limited, summarized, and/or filtered. As shown in the example of FIG. 5B, the filter level selector has been utilized to select an “Entire Organization” option—e.g., as opposed to limiting the presented data to a particular organization level such as division, fleet, geographic area and/or location, business group, entity, and/or other business and/or logical classification. In some embodiments, the filter value selector 536 may be utilized (e.g., in tandem with the filter level selection) to define a filter to apply to the data presented by the interface. As depicted in the example of FIG. 5B, no specific filter value (e.g., other than perhaps the insurance type and/or organizational classification) has been selected and/or defined. In some embodiments, a user may actuate a filter application button 538 to apply a defined filter (e.g., selected via filter value selector 536) in order to refresh, update, and/or modify the information presented via the interface based on the filter.

In some embodiments, the interface 530 may comprise one or more tabs 542, 544 via which specific types of claim management data may be presented. In some embodiments, the interface may comprise an open inventory tab 542 that provides summary data, for example, metrics, tools, and/or options that facilitate customer-driven claim management of a customer's open claims, and/or a claim activity tab 544 that provides summary data, metrics, tools, and/or options that facilitate customer-driven claim management of a customer's claims with recent activity.

In some embodiments, as shown in FIG. 5B, the open inventory tab 542 may comprise a first portion 550 for providing claim summary information based on a first sort, rank, and/or filter and at least a second portion 556 for providing claim summary information associated with a subset of the information presented in the first portion 550 (e.g., based on a selection of one or more summary records from the first portion).

In some embodiments, as shown in FIG. 5B, claim summary information 550 may comprise respective counts of open claims 548-3, claims having an associated claim amount not less than one or more predetermined thresholds 548-4, claims open for not less than one or more predetermined periods of time 548-5, 548-6, claims having related subrogation matters 548-7, claims having related litigation matters 548-8, and/or workers compensation claims that have been challenged 548-9. According to some embodiments, respective totals 554 (e.g., across a plurality of adjusting offices) of various types of claim counts may be presented via the interface 530.

In some embodiments, the open inventory tab 542 may comprise a sort selector 546. The open inventory sort selector 546 may, in some embodiments, comprise a drop-down menu (as depicted in FIG. 5B) that allows a customer to select a field by which data presented by the interface (e.g., one or more types of count information or other type of summary information) is to be sorted. In one example, the drop-down menu may allow for sorting by one or more of adjusting office 548-2, state, and/or organization level. As depicted in the example of FIG. 5B, “Adjusting Office” has been selected as the field via which presented data is to be sorted.

According to some embodiments, selection of a particular summary record in the first portion 550 of the open inventory tab 542 (e.g., by a user selecting a respective selection element 548-1 associated with a particular summary record) may result in presentation in the second portion 556 of claim summary information corresponding to the selected summary record. In some embodiments, the second portion 556 may display claim summary information summarized by claim handler and/or by organization level (e.g., sub-levels of an organization level selected in the first portion). In the example depicted in FIG. 5B, the record corresponding to the adjusting office of “Alpharetta, Ga.; Constru” has been selected and claim summary information for that selected adjusting office is provided in the example second portion, summarized by respective claim handler associated with the selected adjusting office.

According to one example implementation, within the open inventory view, claims may be summarized within one or more important milestone categories and may be organized, for example, by distribution across adjusting offices of an insurance carrier, states, and/or any level of a customer's organization. In accordance with some embodiments, the dashboard is interactive and allows a user to move from a display of summary information down to the individual claim files where detailed information can be found to help determine next steps for efficient claim management. According to the example implementation, users have the ability to filter to a specific line of insurance, filter to a specific segment of their organization, reorganize the grid of information to a different sort field, change threshold amounts for one or more types of criteria, drill down on rows of an upper grid (e.g., a first interface portion) for further breakouts displayed in lower grid (e.g., a second interface portion); or drill down on any displayed number greater than zero to view detailed claim information.

In some embodiments, summary claim information (e.g., claims counts or other determined metrics) may be presented via an interface with associated links 552-1, 552-2, 552-3, 552-4, 552-5, 552-6, 552-7 for accessing more detailed information. In one example, as shown the interface of FIG. 5B, counts of open claims associated with a given adjusting office are displayed as numbers with user-selectable hyperlinks (e.g., link 552-1). Similarly, other counts for different criteria are presented as hyperlinks. When selected by a user, the interface processes a request for presentation about detailed information associated with the claims represented by the count number, and provides claim detail information via the interface.

According to some embodiments, selection of a metric in the first portion 550 (e.g. “18” open claims for “Alpharetta, Ga.; Constru”) and/or selection of a metric in the second portion 556 (e.g., the “2” open claims for “Danny Williams”) in the open inventory tab 542 of the interface 530 of FIG. 5B may cause the example interface 560 as depicted in FIG. 5C to be provided. The interface 560 depicted in FIG. 5C may, for example, comprise a claim data detail window 562. According to some embodiments claim data detail window 562 may include claim information about all claims corresponding to a particular claim count (e.g., in the open inventory tab 542).

In some embodiments, the claim data detail window 562 may comprise one or more types of information associated with one or more particular claims. Such information (e.g., as depicted in FIG. 5C), may comprise, for each respective claim, one or more of: a claim number 566-1, a claimant name 566-2, an accident date 566-3, a total incurred amount 566-4, and/or a selectable link 566-5 for displaying and/or hiding additional information 570 about a claim.

In some embodiments, information about a claim (e.g., displayed in claim data detail window 562 and/or additional information 570) may comprise one or more of: a date reported, an employee contact date, a number of days to initial contact, an indication of a major line of insurance, an indication of a claim file code, an indication of a reporting lag, an indication of a claim duration, an indication of a claim level, an indication of a claim severity code, an indication of whether an attorney is assigned, an indication of whether subrogation is being pursued, an indication of a total amount paid, an indication of an initial incurred amount, an indication of a difference between a current incurred amount and an initial incurred amount, and/or an indication of a total number of changes in the incurred amount for the claim.

According to the example depicted in FIG. 5C, in response to a user's selection of the link for a count of open claims for a specific adjusting office (e.g., “Alpharetta, Ga.: Constru”) the interface 560 has been presented displaying in claim data detail window 562 respective records for each open claim (e.g., grouped by claim handler associated with the adjusting office). Further, according to the example, a user's selection of the link 572 has displayed some additional information 570. According to the example, clicking on the link 572 again will result in closing or hiding the additional information 570.

According to one example implementation, detailed claim information appears (e.g., via an interface) when a user clicks on any number presented via a dashboard view. In some embodiments, users can export a view (e.g., a claim detail view) to a PDF file (e.g., by selecting PDF generator 567 in FIG. 5C) and/or examine a claim more closely to obtain detailed financial information, claim handler notes, etc.

According to one example implementation, a claim activity tab 544, as depicted in example interface 580 of FIG. 5D, may help users easily identify claims for which: status has become new, closed, or reopened; file type has changed (e.g., file type has changed from a medical expense only workers compensation claim to a workers compensation claim involving other types of expenses); changes have been made to incurred and/or paid amounts; employee is now out of work; and/or employee is now on restricted duty. In one example, users may easily navigate between different activity categories via a drop-down menu and view respective claim count totals for each category within this dropdown. Users may have the ability to filter to a specific line of insurance, filter to a specific segment of their organization, reorganize a grid of information to a different sort field, change threshold amounts, and/or click on any claim number to view detailed claim information. In some embodiments, views may be exported to spreadsheet or PDF file formats.

According to some embodiments, selection of the claim activity tab 544 of the interface 520 of FIG. 5A may cause the interface as depicted in FIG. 5D to be provided. In some embodiments, the interface may comprise various drop-down menus (and/or other features) from which the customer/user may select summarization and/or filter options. The interface 580 may comprise, for example, sort selector 582 and/or an activity type selector 584. The sort selector 582 may, according to some embodiments, comprise a drop-down menu that allows the customer to select one or more sort criteria for which data presented by the interface may be sorted (e.g., by major line of insurance, organization level, state, and/or customized customer criteria). As shown in the example of FIG. 5D, the insurance type selector has been utilized to select “Major Line of Insurance.”

The activity type selector 584 may, in some embodiments, comprise a drop-down menu (as depicted in FIG. 5D) that allows the customer to select a particular type of claim activity by which the data presented by the interface may be limited, summarized, and/or filtered. As shown in the example of FIG. 5D, the activity type selector has been utilized to select an “Incurred Changes” option. Other potential activity types may include one or more of the following: new/opened claims, closed claims, reopened claims, incurred amount changes, paid amount changes, claim file type changes, claims with associated lost time, and/or claims where an associated employee is on restricted duty.

The interface 580 for presenting claim activity information may, in some embodiments, comprise a claims change threshold filter 586 that allows the customer to select a particular amount by which the claims presented by the interface may be limited, summarized, and/or filtered. As shown in the example of FIG. 5D, the claims change threshold filter 586 has been utilized to select a threshold amount for incurred changes of “$25,000.” When the filter is applied (e.g., by the user clicking on an associated filter button 588), the claims presented may be limited to only those having (e.g., within a defined activity period) associated total incurred amounts of at least the claims change threshold. Similar user-selected filtering may be provided, as appropriate, for other types of activities.

In some embodiments, as shown in FIG. 5D, a portion of an interface for presenting claim information based on claim activity may comprise one or more types of information associated with respective claims, including, without limitation: an activity date 590-1, a claimant name 590-2, a claim ID 590-3, a type of claim file 590-4, a total paid amount 590-5, a total incurred amount 590-6, and an accident date 590-7.

According to some embodiments, an interface for a claim management dashboard allows users to set one or more different rules as preferences linked to their respective user identifiers. These rules may be stored, for example, in a preferences database (e.g., user preferences database 240g) so that every time a user accesses the dashboard the user's rules and other preferences are applied (e.g., in presenting a user interface).

According to some embodiments, the preferences option 540 depicted in FIG. 5B may be selected by a user to cause provision of a preferences window 596, as shown in the example interface 595 of FIG. 5E. The preferences window 596 may, for example, comprise various portions and/or features that allow the customer to select, identify, define, and/or otherwise determine and/or save one or more preferences. As depicted in FIG. 5E, for example, the preferences window 596 may comprise a general tab 597 that allows the customer to set various general preferences, such as whether certain types of claims should be excluded 598; threshold amounts 600, 606, 608 for summarizing claim information based on incurred amount, number of incurred changes, amount of incurred changes, and/or paid amounts; and/or a period of days 604 for which to show claim activity (e.g., to specify a preceding period by which to define recent activity) for data presented via the corresponding interface(s).

In some embodiments, the preferences window 596 may comprise one or more preferences for limiting data and/or sorting data (e.g., via a limiting tab and/or a sorting tab). Accordingly, preferences may comprise one or more definition options that allow a user (e.g., an end user, a system administrator) to set default values, value ranges and/or criteria for limiting and/or filtering the types of claims for which information is determined and/or displayed for an interface, by providing one or more respective criteria associated with claims. Alternatively, or in addition, a user may be able to set preferences for how displayed claim information (e.g., claim count information) is sorted (e.g., when presented via interface 530 of FIG. 5B), by specifying one or more types of information to use for sorting. Accordingly, in one or more embodiments, a user may limit and/or sort information about claims based on one or more types of claim information (e.g., database fields), such as, without limitation:

date of accident

account number

adjusting office

carrier code

claim number

claim status

date notice of claim was received

indication of type of claim (e.g., file prefix)

incident indicator

line of insurance

organization identifier

policy number

state in which accident took place

state for purpose of benefits (e.g., WC benefits)

state associated with billing

customer-specific organization value (e.g., division code, project code)

In one example, a user may limit (e.g., via preferences window 596) the claims for which claim information is displayed to those having associated accident dates on a particular date and/or in a particular date range, by inputting the relevant criteria. In another example, a user may specify a default sort order (e.g., via preferences window 596) by picking one or more data fields (e.g., via one or more drop-down menus).

In some embodiments, the preferences window 596 may comprise one or more of a save button 610, a cancel button 612, and/or a display defaults button 614 for displaying information about predetermined default values for a claim management system (e.g., as set by a system administrator).

According to some embodiments, a user may be able to access additional detailed information about a particular claim (e.g., about only one particular claim) by clicking on or otherwise selecting a displayed claim ID (e.g., claim IDs 568, 590-3) for a particular claim, as depicted in FIG. 5C and FIG. 5D, respectively. According to some embodiments, requesting additional claim information may result in querying a claim status database and presenting, via the interface, the more detailed information. As depicted in the example interface 620 of FIG. 5F, such information may comprise various types of information discussed in this disclosure and that may be helpful to a user in understanding and/or managing a particular claim.

According to some embodiments, when requesting information for a particular claim (e.g., using a clickable claim number on an interface) in a mobile version of the application, a user may not have access to one or more types of applications, data sources, databases, and/or data tables that may be available if the user were in an office network environment. For example, a separate claim status application accessible via a desktop version of the claim management dashboard application in a corporate environment may not be accessible to query for detailed claim status information when a user is out of the office. Accordingly, in some embodiments, a claim management application (e.g., running on a web application server) may be enhanced for mobile users to retrieve claim status information (e.g., real-time financials and/or claim handler annotations or notes) as necessary from a claim status system inaccessible to remote users, and provide the claim status information to the user via a claim management dashboard interface (e.g., interface 620 of FIG. 5F). In this way, a similar user experience and similar functionality may be made available in both the mobile and desktop claim management systems.

According to some embodiments, a claim management dashboard may be optimized to display open inventory and/or claim activity information via one or more tablet devices or other types of mobile devices. Accordingly, the same functionality that exists on a desktop version of the dashboard may be provided via a tablet device, for example, so that users who are out of their office can still access information they may need to do their jobs.

While various components of the example interfaces 520, 530, 560, 580, 595, 620 have been described with respect to certain labels, layouts, headings, windows, tabs, pages, titles, and/or configurations, these features have been presented for reference and example only. Other labels, layouts, headings, windows, tabs, pages, titles, and/or configurations may be implemented without deviating from the scope of embodiments herein. Similarly, while a certain number and/or type of windows, tabs, information screens, form fields, data types, graphical elements, and/or data entry options have been presented, variations thereof may be practiced in accordance with some embodiments.

In some embodiments, any one or more interfaces may comprise one or more links to other web pages, web sites, and/or other external data. Such data may, for example, be contextually provided and/or determined based on portions of the interface interacted with and/or viewed by a customer. In some embodiments, such data may comprise various guidelines, reference material, training material, and/or other guidance regarding claim management.

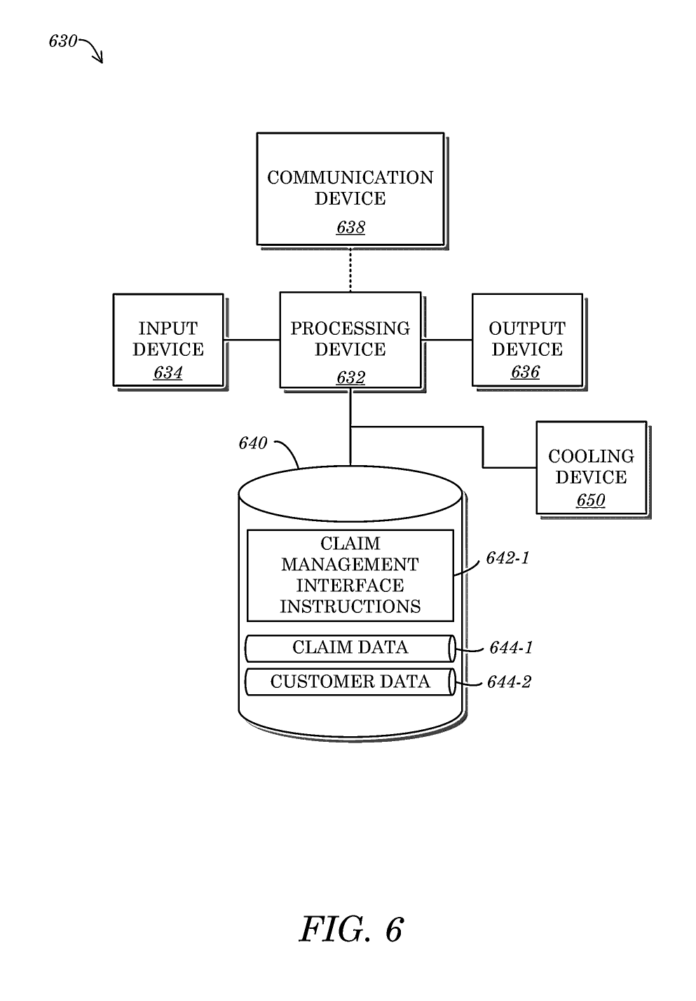

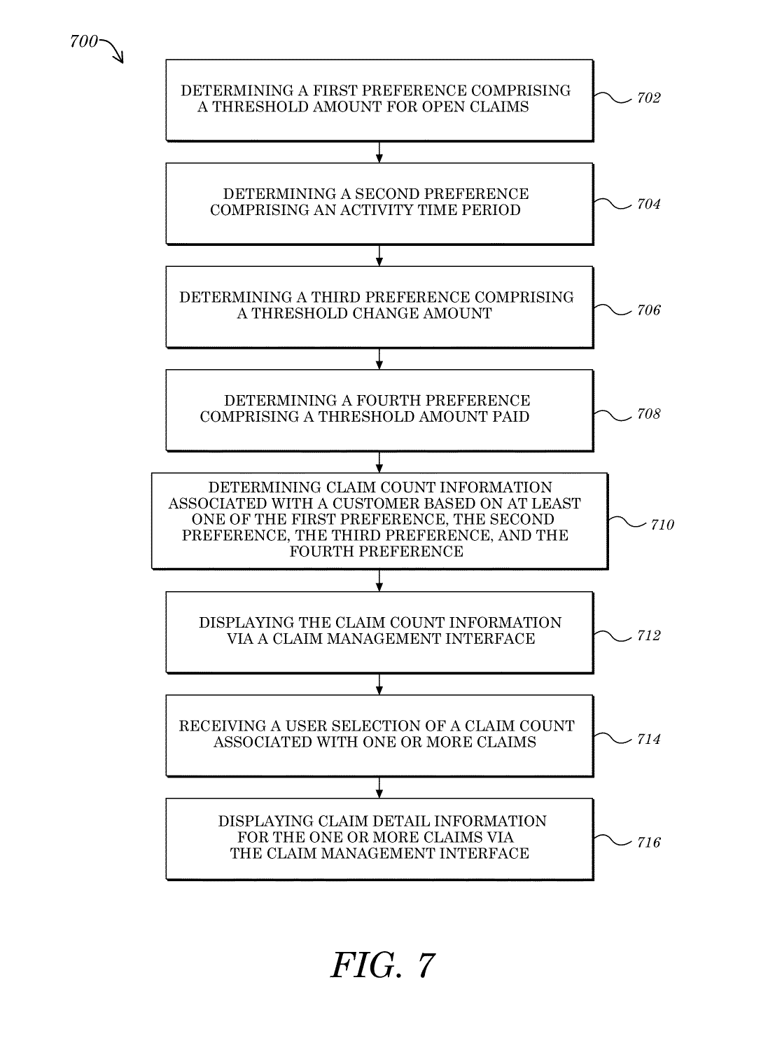

Turning to FIG. 6, a block diagram of an apparatus 630 according to some embodiments is shown. In some embodiments, the apparatus 630 may be similar in configuration and/or functionality to any of the customer devices 102a-n and/or the claim management server 110 of FIG. 1 and/or may comprise a portion of the system 200 of FIG. 2 herein. The apparatus 630 may, for example, execute, process, facilitate, and/or otherwise be associated with the method 400 and/or the method 700 described in conjunction with FIG. 4 and FIG. 7, respectively. In some embodiments, the apparatus 630 may comprise a processing device 632, an input device 634, an output device 636, a communication device 638, and/or a memory device 640. According to some embodiments, any or all of the components 632, 634, 636, 638, 640 of the apparatus 630 may be similar in configuration and/or functionality to any similarly named and/or numbered components described herein. Fewer or more components 632, 634, 636, 638, 640 and/or various configurations of the components 632, 634, 636, 638, 640 may be included in the apparatus 630 without deviating from the scope of embodiments described herein.

According to some embodiments, the processing device 632 may be or include any type, quantity, and/or configuration of electronic and/or computerized processor that is or becomes known. The processing device 632 may comprise, for example, an Intel® IXP 2800 network processor or an Intel® XEON™ Processor coupled with an Intel® E7501 chipset. In some embodiments, the processing device 632 may comprise multiple inter-connected processors, microprocessors, and/or micro-engines. According to some embodiments, the processing device 632 (and/or the apparatus 630 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 630 comprises a server such as a blade server, necessary power may be supplied via a standard AC outlet, power strip, surge protector, and/or Uninterruptible Power Supply (UPS) device.

In some embodiments, the input device 634 and/or the output device 636 are communicatively coupled to the processing device 632 (e.g., via wired and/or wireless connections and/or pathways) and they may generally comprise any types or configurations of input and output components and/or devices that are or become known, respectively. The input device 634 may comprise, for example, a keyboard that allows an operator of the apparatus 630 to interface with the apparatus 630 (e.g., by a consumer, such as to conduct customer-driven claim management). In some embodiments, the input device 634 may comprise a sensor configured to provide information to the apparatus 630 and/or the processing device 632. The output device 636 may, according to some embodiments, comprise a display screen and/or other practicable output component and/or device. The output device 636 may, for example, provide a claim management interface to a customer (e.g., via a website). According to some embodiments, the input device 634 and/or the output device 636 may comprise and/or be embodied in a single device such as a touch-screen monitor.

In some embodiments, the communication device 638 may comprise any type or configuration of communication device that is or becomes known or practicable. The communication device 638 may, for example, comprise a network interface card (NIC), a telephonic device, a cellular network device, a router, a hub, a modem, and/or a communications port or cable. In some embodiments, the communication device 638 may be coupled to provide data to a customer device (not shown in FIG. 6), such as in the case that the apparatus 630 is utilized to provide a claim management interface to a customer as described herein. The communication device 638 may, for example, comprise a cellular telephone network transmission device that sends signals to a customer and/or subscriber handheld, mobile, and/or telephone device. According to some embodiments, the communication device 638 may also or alternatively be coupled to the processing device 632. In some embodiments, the communication device 638 may comprise an IR, RF, Bluetooth™, and/or Wi-Fi® network device coupled to facilitate communications between the processing device 632 and another device (such as a customer device and/or a third-party device).

The memory device 640 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of claim management interface instructions 642-1, claim data 644-1, and/or customer data 644-2. In some embodiments, the claim management interface instructions 642-1 may be utilized by the processing device 632 to provide output information via the output device 636 and/or the communication device 638 (e.g., the claim management interface at 404 of the method 400 of FIG. 4).

According to some embodiments, the claim management interface instructions 642-1 may be operable to cause the processing device 632 to process claim data 644-1 and/or customer data 644-2. Claim data 644-1 and/or customer data 644-2 received via the input device 634 and/or the communication device 638 may, for example, be analyzed, sorted, filtered, decoded, decompressed, ranked, scored, plotted, and/or otherwise processed by the processing device 632 in accordance with the claim management interface instructions 642-1. In some embodiments, claim data 644-1 and/or customer data 644-2 may be fed by the processing device 632 through one or more mathematical and/or statistical formulas and/or models in accordance with the claim management interface instructions 642-1 to provide a claim management interface in accordance with embodiments described herein.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 630. According to some embodiments, the memory device 640 may be incorporated into and/or otherwise coupled to the apparatus 630 (e.g., as shown) or may simply be accessible to the apparatus 630 (e.g., externally located and/or situated).

In some embodiments, the apparatus 630 may comprise a cooling device 650. According to some embodiments, the cooling device 650 may be coupled (physically, thermally, and/or electrically) to the processing device 632 and/or to the memory device 640. The cooling device 650 may, for example, comprise a fan, heat sink, heat pipe, radiator, cold plate, and/or other cooling component or device or combinations thereof, configured to remove heat from portions or components of the apparatus 630.

In accordance with some embodiments discussed in this disclosure, a method for claim management may comprise one or more of: (i) determining at least one preference of a user for presenting information via a claim management interface; (ii) determining a preference for presenting information about open claims based on a threshold amount associated with the claims; (iii) determining a preference for presenting information about claims having associated activity within a predetermined activity time period; (iv) determining a preference for presenting information about claims associated with at least a threshold change amount in dollar value; and/or (v) determining a preference for presenting information about claims associated with at least a threshold amount paid on the claims.

Turning to FIG. 7, a flowchart of a method 700 according to some embodiments is shown. In some embodiments, the method 700 may be performed and/or implemented by and/or otherwise associated with one or more specialized computerized processing devices (e.g., apparatus 630 of FIG. 6), computers, computer terminals, and/or computer servers (e.g., the claim management server 110 of FIG. 1 and/or the processing layer 210 of FIG. 2), computer systems (e.g., the systems 100, 200 of FIG. 1 and/or FIG. 2, and/or any portions or combinations thereof) and/or networks (e.g., the network 104 of FIG. 1), and/or any portions or combinations thereof. In some embodiments, the method 700 may be embodied in, facilitated by, and/or otherwise associated with various input mechanisms and/or interfaces such as the interfaces 220, 520, 530, 560, 580, 595, 620 described with respect to FIG. 2, FIG. 5A, FIG. 5B, FIG. 5C, FIG. 5D, FIG. 5E, and/or FIG. 5F herein. According to some embodiments, the method 700 may comprise a method for customer-driven claim management.

In some embodiments, the method 700 may comprise one or more of: determining a first preference comprising a threshold amount for open claims, at 402; determining a second preference comprising an activity time period, at 404; determining a third preference comprising a threshold change amount, at 406; and/or determining a fourth preference comprising a threshold amount paid, at 408. As discussed with respect to example interface 620, determining a preference for presenting information via a claim management interface may comprise receiving, from a user and/or from a data storage device, an indication of a preference of a user for what types of claim information is displayed and/or how the information is displayed.

In some embodiments, the method 700 may comprise determining claim count information associated with a customer based on at least one of the first preference, second preference, third preference, and fourth preference, at 710, and displaying the claim count information via a claim management interface, at 712. In one or more embodiments, a claim management server, for example, may filter claims and/or information about claims to present via a claim management interface, based on preferences of a user. A claim management interface may be configured, in accordance with user preferences, to represent claim counts corresponding to claims that meet one or more criteria selected by a user and/or to represent information about only those claims having activity within a predetermined activity time period (e.g., defined and/or accepted by the user as a preference).

In some embodiments, the method 700 may comprise receiving a user selection of a claim count associated with one or more claims, at 714, and displaying claim detail information for the one or more claims via the claim management interface, at 716. As described in this disclosure with respect to various embodiments, a user may be able to select (e.g., by clicking on) a link associated with an indicated claim count (e.g., representing a count of claims that meet the user's preference(s)). In response (e.g., in accordance with interface instructions), the claim management interface may display to the user additional and/or more detailed information about the claims represented by the claim count.

According to some embodiments, a claim management dashboard may help business insurance customers efficiently and easily manage their claims. As discussed with respect to various embodiments, a claim management dashboard may comprise an analytical tool allowing customers to analyze all open claims and/or those claims whose recent activities may have a significant impact on overall loss costs. For users who may not know what to look for when managing claims, a claim management dashboard may incorporate best practices and/or provide guided analysis (e.g., by identifying those claims that most likely need to be managed to achieve optimal financial results).

According to some embodiments, within an open inventory view, claims may be summarized within important milestone categories and/or organized by distribution across adjusting offices, states, or any level of a customer's organization. In some embodiments, a dashboard is fully interactive, allowing a user to move from summary information down to the individual claim files where detailed information can be found to help determine next steps. In some embodiments, contact information may be included so that customers can communicate suggestions and/or questions (e.g., via notes and/or other types of annotations for a claim file) directly to the appropriate claim handler (e.g., of an insurance carrier).

According to some embodiments, a claim management dashboard incorporates information associated with claims where recent activities have occurred. Such activities may include, for example and without limitation: Status has become New, Closed, or Reopened; File Prefix has transferred from CM to CB; Incurred and Paid Changes, Employee is Out of Work and Employee is on Restricted Duty. By staying up to date on changes occurring with claims, customers can help to mitigate unnecessary costs and prepare for financial implications that may result from these activities.

According to some embodiments, a claim management system may allow a plurality of users to view, simultaneously, the same claim information and/or same claim management interface. In some embodiments, a virtual claim review function may allow, for example, a customer and at least one claim profession to view instances of the same claim management interface in order to colloborate in a virtual claim review process. In one embodiment, a claim management system may allow for screen sharing of one user's computer desktop with another user via a screen sharing service (e.g., the WebEx™ web conferencing service by Cisco™). Accordingly, some embodiments allow for a claim handler and a customer (e.g., a risk manager of an insured business) to interact remotely and/or virtually, reducing travel costs that might otherwise have been incurred in order to have the users conduct a claim review at the same location.

According to some embodiments, a claim management interface may allow a user to connect results to resource information via hyperlinks. In one example, claim management data could be linked to a carrier's proprietary library of information and/or to external industry information.

In one embodiment, a claim management interface may allow a user to annotate results to aid communication/collaboration activities (e.g., among different users). In another embodiment, a claim management interface may enable users to select or mark one or more claims via the interface so that at the end of their analysis they can create a document that contains information for all the marked claims (e.g., for distribution or archival purposes).

According to some embodiments, in addition to or in lieu one or more of the types of metrics discussed in this disclosure, an interface may allow a user to add one or more other metrics (e.g., metrics defined by an individual user).

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

What is claimed is:

1. An apparatus comprising:
a processor; and
a computer-readable memory in communication with the processor, the computer-readable memory storing instructions configured so that when executed by the processor the instructions direct the processor to:
determine at least one preference of a user for presenting claim information via a claim management interface;
determine, based on the at least one preference, claim count information about at least one claim associated with the user;
generate, via the claim management interface, a representation of the claim count information;
receive, via the claim management interface, an indication of a selection by the user of a claim count associated with one or more claims; and
transmit, via the claim management interface, claim detail information for the one or more claims.

2. The apparatus of claim 1, wherein the at least one preference comprises a threshold amount associated with open claims.

3. The apparatus of claim 1, wherein the at least one preference comprises a preference for claims having associated activity within a predetermined activity time period.

4. The apparatus of claim 1, wherein the at least one preference comprises a preference for claims associated with at least a threshold change amount in dollar value.

5. The apparatus of claim 1, wherein the at least one preference comprises a preference for claims associated with at least a threshold amount paid.

6. The apparatus of claim 1, the instructions being further configured to direct the processor to:
receive, from the user, an annotation associated with a claim; and
store, in a data storage device, an indication of the annotation in association with the claim.

7. The apparatus of claim 1, the instructions being further configured to direct the processor to:
facilitate a virtual claim review process by presenting the claim management interface to the user and to at least one other user.

8. The apparatus of claim 1, the instructions being further configured to direct the processor to:
transmit, to the user, an alert indicating that at least one claim associated with the user has been identified based on the at least one preference.

9. The apparatus of claim 1, wherein the at least one preference comprises:
a threshold amount associated with open claims,
a predetermined activity time period,
a threshold change amount in dollar value, and
a threshold amount paid.

10. The apparatus of claim 1, wherein the at least one preference comprises at least one of the following:
a default sort order, and
a filter for determining the claim information.

11. A non-transitory computer readable medium storing instructions configured so that when executed by a processor of a computing device the instructions direct the processor to:
determine, by a computing device comprising at least one processor, at least one preference of a user for presenting claim information via a claim management interface;
determine, by the computing device, based on the at least one preference, claim count information about at least one claim associated with the user;
generate, by the computing device via the claim management interface, a representation of the claim count information;
receive, by the computing device via the claim management interface, an indication of a selection by the user of a claim count associated with one or more claims; and
transmit, by the computing device via the claim management interface, claim detail information for the one or more claims.

12. The computer readable medium of claim 11, wherein the at least one preference comprises a threshold amount associated with open claims.

13. The computer readable medium of claim 11, wherein the at least one preference comprises a preference for claims having associated activity within a predetermined activity time period.

14. The computer readable medium of claim 11, wherein the at least one preference comprises a preference for claims associated with at least a threshold change amount in dollar value.

15. The computer readable medium of claim 11, wherein the at least one preference comprises a preference for claims associated with at least a threshold amount paid.

16. The computer readable medium of claim 11, the instructions being further configured to direct the processor to:
receive, from the user, an annotation associated with a claim; and
store, in a data storage device, an indication of the annotation in association with the claim.

17. The computer readable medium of claim 11, the instructions being further configured to direct the processor to:
facilitate a virtual claim review process by presenting the claim management interface to the user and to at least one other user.

18. The computer readable medium of claim 11, the instructions being further configured to direct the processor to:
transmit, to the user, an alert indicating that at least one claim associated with the user has been identified based on the at least one preference.

19. The computer readable medium of claim 11, wherein the at least one preference comprises:
a threshold amount associated with open claims,
a predetermined activity time period,
a threshold change amount in dollar value, and
a threshold amount paid.

20. The computer readable medium of claim 11, wherein the at least one preference comprises at least one of the following:
a default sort order, and
a filter for determining the claim information.
